(19) United States
(12) Patent Application Publication
(10) Pub. No.: US 2020/0410988 A1
(43) Pub. Date: Dec. 31, 2020

(54) INFORMATION PROCESSING DEVICE, INFORMATION PROCESSING SYSTEM, AND INFORMATION PROCESSING METHOD, AND PROGRAM

(71) Applicant: Sony Corporation, Tokyo (JP)

(72) Inventor: Yoshinori MAEDA, Kanagawa (JP)

(73) Assignee: Sony Corporation, Tokyo (JP)

(21) Appl. No.: 16/975,717

(22) PCT Filed: Jan. 10, 2019
(86) PCT No.: PCT/JP2019/000564

§ 371 Date: Aug. 26, 2020

(30) Foreign Application Priority Data
Mar. 13, 2018 (JP) 2018-045445

(51) Int. Cl. G10L 15/10; G10L 15/28; G10L 15/02

(52) U.S. Cl. CPC G10L 15/10; G10L 15/02; G10L 15/28

(57) ABSTRACT

A device and method that enable the execution of processing requested by a user based on a natural user's speech without using an unnatural default speech start keyword are provided. The present disclosure has a keyword analysis unit that assesses whether or not a user's speech is a speech start keyword, and the keyword analysis unit has a user registration speech start keyword processing unit that assesses whether or not the user's speech is a user registration speech start keyword registered by the user in advance. The user registration speech start keyword processing unit assesses that the user's speech is the user registration speech start keyword, in a case where the user's speech is similar to a pre-registered keyword, and a pre-registered registration condition, such as an application being executed, or an input time or input timing of the user's speech, satisfies a registration condition.

### TECHNICAL FIELD

The present disclosure relates to an information processing device, an information processing system, and an information processing method, and a program. More specifically, the present disclosure relates to an information processing device, an information processing system, and an information processing method, and a program for performing voice recognition on a user's speech, and executing various processes and making various responses based on the recognition result.

### BACKGROUND ART

Recently, a voice recognition device is increasingly used that performs voice recognition on a user's speech, and executes various processes and makes various responses based on the recognition result.

The voice recognition device described above analyzes a user's speech input via a microphone and performs a process according to the analysis result.

For example, when the user says “Tell me tomorrow's weather”, the voice recognition device acquires weather information from a weather information providing server, generates a system response based on the acquired information, and outputs the generated response from the speaker. Specifically, the voice recognition device outputs the following system speech, for example.

System speech=“Tomorrow's weather is sunny. However, there may be a thunderstorm in the evening.”

Most of voice recognition devices are configured not to always perform voice recognition on all user's speeches, but to start speech recognition in response to detection of a predetermined “speech start keyword” such as a trigger word for the device.

That is, when the user activates a voice input, the user first says a predetermined “speech start keyword”.

The voice recognition device transfers to a voice input awaiting state in response to the detection of input of the “speech start keyword”. After the state transition, the voice recognition device starts voice recognition of the user's speech.

Note that many devices are configured to perform word detection based on only a voice waveform for the “speech start keyword”, so that they can detect whether or not the “speech start keyword” is issued without performing a voice recognition process.

The process of starting the voice recognition process based on the detection of the “speech start keyword” is necessary whatever state the device is in.

However, this is bothersome for the user, because the user has to say a specific “speech start keyword” every time.

For example, in a case such as a case where the user requests the voice recognition device to operate some application, the user has to say a specific “speech start keyword” before saying the word to request the operation. The user also has to do that in a case where he/she wants to operate the application immediately, in a case where he/she wants to perform a quick operation, or in other cases, and this has negative effects on natural voice operation.

In addition, in a case where there is no speech start keyword, a system needs to always keep waiting for a user's speech, which increases power cost, and may also cause a wrong behavior due to unexpected input of external sound or erroneous recognition.

Note that, for example, Patent Document 1 (Japanese Patent Application Laid-Open No. 2008-146054) is provided as a prior art that discloses a voice recognition process.

This document discloses, for example, a method of identifying a speaker on the basis of a result of an analysis of sound quality (frequency identification/voiceprint) of a voice input to a device.

### CITATION LIST

### Patent Document

Patent Document 1: Japanese Patent Application Laid-Open No. 2008-146054

### SUMMARY OF THE INVENTION

### Problems to be Solved by the Invention

The present disclosure has been made in view of, for example, the above problems, and an object of the present disclosure is to provide an information processing device, an information processing system, and an information processing method, and a program that simply enable operation based on voice only by a speech for requesting operation, etc. without requiring a user to input a specific speech start keyword, when, for example, the user intends to operate an application immediately, the user intends to carry out a quick operation, etc.

An object of one embodiment of the present disclosure is to provide an information processing device, an information processing system, and an information processing method, and a program that enable, in a case where a user intends to carry out a quick operation, user interface (UI) operation based on more natural voice by activating a specific speech start keyword according to state, time, place, etc. in this case.

### Solutions to Problems

A first aspect of the present disclosure provides an information processing device including a keyword analysis unit that assesses whether or not a user's speech is a speech start keyword,

in which the keyword analysis unit includes a user registration speech start keyword processing unit that assesses whether or not the user's speech is a user registration speech start keyword that is registered in advance by a user, and

the user registration speech start keyword processing unit assesses that the user's speech is the user registration speech start keyword only in a case where the user's speech is similar to a pre-registered keyword and satisfies a registration condition registered in advance.

Further, a second aspect of the present disclosure provides an information processing system including: a user terminal; and a data processing server,

in which the user terminal includes a voice input unit that receives a user's speech,

the data processing server includes a user registration speech start keyword processing unit that assesses whether or not the user's speech received from the user terminal is a user registration speech start keyword that is registered in advance by a user, and

the user registration speech start keyword processing unit assesses that the user's speech is the user registration speech start keyword only in a case where the user's speech is similar to a pre-registered keyword and satisfies a registration condition registered in advance.

Further, a third aspect of the present disclosure provides an information processing method executed by an information processing device,

in which a user registration speech start keyword processing unit performs a user registration speech start keyword assessment step for assessing whether or not a user's speech is a user registration speech start keyword that is registered in advance by a user, and

in the user registration speech start keyword assessment step, the user's speech is assessed to be the user registration speech start keyword only in a case where the user's speech is similar to a pre-registered keyword and satisfies a registration condition registered in advance.

Further, a fourth aspect of the present disclosure provides an information processing method executed by an information processing system that includes a user terminal and a data processing server,

in which the user terminal executes a voice input process of receiving a user's speech,

the data processing server executes a user registration speech start keyword assessment process of assessing whether or not the user's speech received from the user terminal is a user registration speech start keyword that is registered in advance by a user, and

in the user registration speech start keyword process, the user's speech is assessed to be the user registration speech start keyword only in a case where the user's speech is similar to a pre-registered keyword and satisfies a registration condition registered in advance.

Further, a fifth aspect of the present disclosure provides a program that causes an information processing device to execute information processing,

the program causing a user registration speech start keyword processing unit to execute a user registration speech start keyword assessment step for assessing whether or not the user's speech is a user registration speech start keyword that is registered in advance by a user, and

causing the user registration speech start keyword processing unit to assess that the user's speech is the user registration speech start keyword in the user registration speech start keyword assessment step, only in a case where the user's speech is similar to a pre-registered keyword and satisfies a registration condition registered in advance.

Note that the program of the present disclosure is, for example, a program that can be provided to an information processing device or a computer system capable of executing various program codes by a storage medium or a communication medium that provides the program codes in a computer-readable format. By providing such a program in a computer-readable format, processing according to the program can be performed in the information processing device or computer system.

Other objects, features, and advantages of the present disclosure will become apparent from the detailed description based on the embodiments of the present disclosure described later and the accompanying drawings.

It is to be noted that the system in the present specification refers to a logical set of multiple devices, and the respective devices are not limited to be housed within a single housing.

### Effects of the Invention

According to the configuration of the embodiment of the present disclosure, a device and method that enable the execution of processing requested by a user based on a natural user's speech without using an unnatural default speech start keyword can be achieved.

Specifically, for example, a keyword analysis unit is provided that assesses whether or not the user's speech is a speech start keyword, and the keyword analysis unit has a user registration speech start keyword processing unit that assesses whether or not the user's speech is a user registration speech start keyword registered by a user in advance. The user registration speech start keyword processing unit assesses that the user's speech is the user registration speech start keyword, in a case where the user's speech is similar to a pre-registered keyword, and a pre-registered registration condition, such as an application being executed, or an input time or input timing of the user's speech, satisfies a registration condition.

With this configuration, the device and method that enable the execution of processing requested by a user based on a natural user's speech without using an unnatural default speech start keyword can be achieved.

It should be noted that the effects described in the present specification are merely illustrative and not restrictive, and may have additional effects.

### BRIEF DESCRIPTION OF DRAWINGS

FIG. 1 is a diagram for describing an example of an information processing device that makes a response and performs a process based on a user's speech.

FIG. 2 is a diagram illustrating a configuration example and a usage example of the information processing device.

FIG. 3 is a diagram illustrating a specific configuration example of the information processing device.

FIG. 4 is a diagram for describing a speech start keyword assessment process executed by the information processing device and a threshold.

FIG. 5 is a diagram for describing the speech start keyword assessment process and correction of the threshold.

FIG. 6 is a diagram for describing an example of registration data in a user registration keyword holding unit.

FIG. 7 is a diagram for describing an example of registration data in the user registration keyword holding unit.

FIG. 8 is a diagram for describing a specific example of data collected by a user registration keyword management unit.

FIG. 9 is a diagram for describing a specific example of data to be presented based on data collected by the user registration keyword management unit.

FIG. 10 is a diagram for describing a specific example of a process executed by the information processing device.

FIG. 11 is a diagram for describing a specific example of a process executed by the information processing device.

FIG. 12 is a diagram for describing a specific example of a process executed by the information processing device.

FIG. 13 is a diagram for describing a specific example of a process executed by the information processing device.

FIG. 14 is a diagram for describing a specific example of a process executed by the information processing device.

FIG. 15 is a diagram for describing a specific example of a process executed by the information processing device.

FIG. 16 is a diagram for describing a specific example of a process executed by the information processing device.

FIG. 17 is a diagram for describing a specific example of a process executed by the information processing device.

FIG. 18 is a diagram for describing a specific example of a process executed by the information processing device.

FIG. 19 is a diagram for describing a specific example of a process executed by the information processing device.

FIG. 20 is a flowchart for describing a sequence of a process executed by the information processing device.

FIG. 21 is a diagram for describing a configuration example of an information processing system.

FIG. 22 is a diagram for describing a hardware configuration example of the information processing device.

### MODE FOR CARRYING OUT THE INVENTION

An information processing device, an information processing system, and an information processing method, and a program according to the present disclosure will be described below in detail with reference to the drawings. Note that the description will be given in the following order.

1. Overview of process executed by information processing device

2. Configuration example of information processing device

3. Specific examples of process executed by information processing device

4. Sequence of process executed by information processing device

5. Configuration examples of information processing device and information processing system

6. Configuration example of hardware of information processing device

7. Summary of configuration of present disclosure

### 1. Overview of Process Executed by Information Processing Device

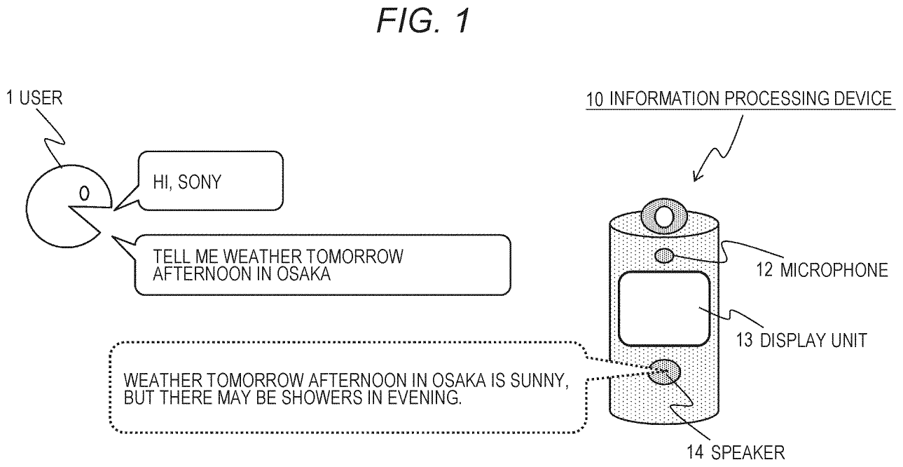

First, an overview of a process executed by an information processing device according to the present disclosure will be described with reference to FIG. 1.

FIG. 1 is a diagram showing an example of a process executed by an information processing device 10 that recognizes a user's speech issued from a user 1 and responds to the speech.

The information processing device 10 detects that the user's speech such as “Hi, Sony” is the “speech start keyword”, and starts a voice recognition process on the next user's speech according to the detection result. That is, the information processing device executes the voice recognition process on the following user's speech.

User's speech=“Tell me weather tomorrow afternoon in Osaka”

The information processing device 10 executes word detection based on the voice waveform for the first user's speech, that is, “Hi, Sony”. Voice waveform information of a “speech start keyword” is registered in advance in a memory of the information processing device 10, and the information processing device 10 assesses whether or not the user's speech is the “speech start keyword” on the basis of the similarity in voice waveform.

That is, at this point, the information processing device 10 detects the “speech start keyword” without performing the voice recognition process.

After detecting that the first user's speech is the “speech start keyword”, the information processing device 10 starts the voice recognition process from the subsequent user's speech. In the example of FIG. 1, the information processing device 10 executes the voice recognition process on the following user's speech.

User's speech=“Tell me weather tomorrow afternoon in Osaka”.

Further, the information processing device 10 executes a process based on the voice recognition result of the user's speech.

In the example shown in FIG. 1, the information processing device 10 acquires data for responding to the user's speech=“Tell me weather tomorrow afternoon in Osaka”, generates a response on the basis of the acquired data, and outputs the generated response through a speaker 14.

In the example shown in FIG. 1, the information processing device 10 provides the following system response.

System response=“The weather tomorrow afternoon in Osaka is sunny, but there may be showers in the evening.”

The information processing device 10 executes a voice synthesis process (text to speech (TTS)) to generate the above system response and outputs the generated system response.

The information processing device 10 generates and outputs the response using knowledge data acquired from a storage unit in the device or knowledge data acquired via a network.

The information processing device 10 shown in FIG. 1 includes a microphone 12, a display unit 13, and a speaker 14, and is configured to be capable of voice input/output and image output.

The information processing device 10 shown in FIG. 1 is called, for example, a smart speaker or an agent device.

Note that the voice recognition process and semantic analysis process for the user's speech may be performed in the information processing device 10, or may be performed in a data processing server that is one of servers 20 in a cloud.

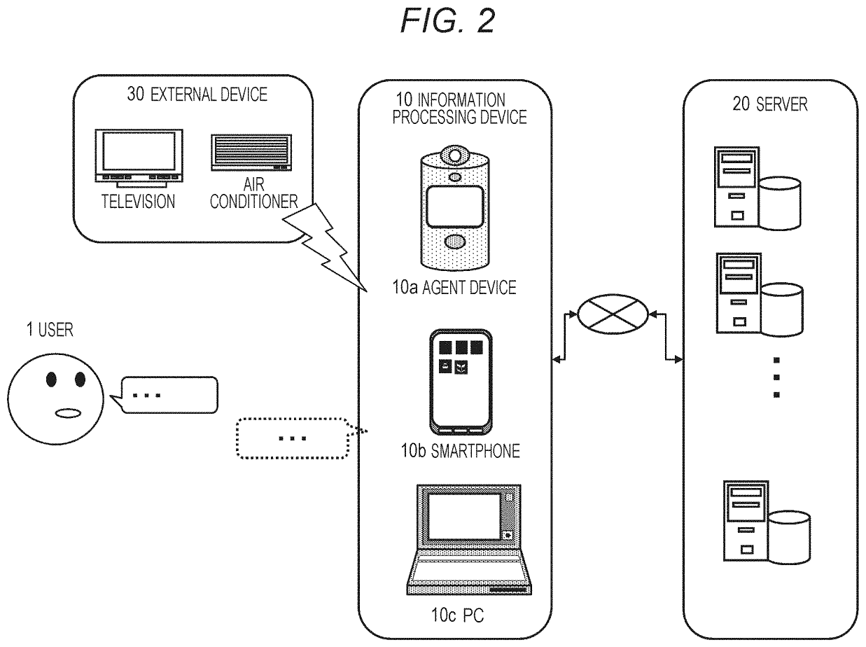

As shown in FIG. 2, the information processing device 10 according to the present disclosure is not limited to an agent device 10a, but may be of various types of devices such as a smartphone 10b and a personal computer (PC) 10c.

In addition to recognizing the speech of the user 1 and making a response based on the user's speech, the information processing device 10 also controls an external device 30 such as a television and an air conditioner illustrated in FIG. 2 based on the user's speech, for example.

For example, in a case where the user's speech indicates a request such as “Change the channel of the television to 1” or “Set the temperature of the air conditioner to 20 degrees”, the information processing device 10 outputs a control signal (Wi-Fi, infrared light, etc.) to the external device 30 on the basis of the voice recognition result of the user's speech, and performs control according to the user's speech.

Note that the information processing device 10 is connected to the server 20 via a network, and is capable of acquiring information necessary for generating a response to the user's speech from the server 20.

Further, as described above, the server may perform the voice recognition process and the semantic analysis process.

### 2. Configuration Example of Information Processing Device

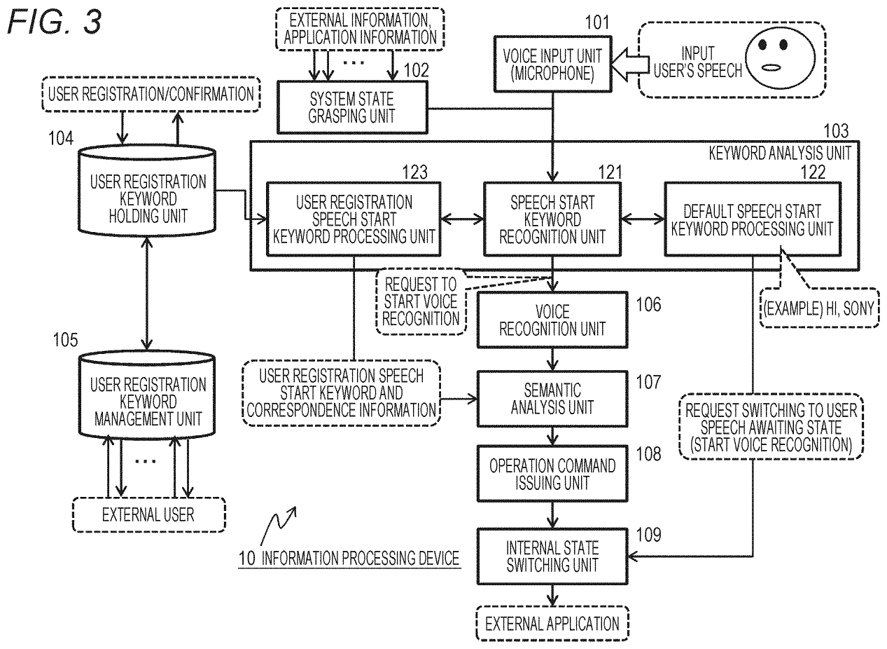

Next, a configuration example of the information processing device 10 according to the present disclosure will be described with reference to FIG. 3.

The information processing device 10 according to the present disclosure enables processing that eliminates the need to input a fixed speech start keyword that is unrelated to a processing request, when the user requests the information processing device 10 to perform processing.

Specifically, when the user intends to cause the information processing device 10 to activate a specific application such as a weather information application or a map application, for example, and to perform processing or make a response by the application, the user only needs to say a processing request without inputting a specific speech start keyword. With this operation, the user enables the device to perform the processing corresponding to the processing request.

FIG. 3 is a block diagram showing a configuration example of the information processing device 10 according to the present disclosure.

As shown in FIG. 3, the information processing device 10 includes a voice input unit (microphone) 101, a system state grasping unit 102, a keyword analysis unit 103, a user registration keyword holding unit 104, a user registration keyword management unit 105, a voice recognition unit 106, a semantic analysis unit 107, an operation command issuing unit 108, and an internal state switching unit 109.

In addition, the keyword analysis unit 103 includes a speech start keyword recognition unit 121, a default speech start keyword processing unit 122, and a user registration speech start keyword processing unit 123.

The keyword analysis unit 103 assesses whether or not the user's speech is the “speech start keyword” on the basis of the voice waveform of a voice signal input from the voice input unit (microphone) 101.

That is, the keyword analysis unit 103 performs processing without performing the voice recognition process that involves converting the user's speech into text.

The keyword analysis unit 103 and the system state grasping unit 102 are data processing units that operate at all times.

On the other hand, the voice recognition unit 106, the semantic analysis unit 107, the operation command issuing unit 108, and the internal state switching unit 109, which are data processing units, start processing on the basis of the processing request from the keyword analysis unit 103. Normally, they are in a sleep state and do not operate.

Hereinafter, each unit will be sequentially described.

Voice Input Unit (Microphone) 101

The voice input unit (microphone) 101 is a voice input unit (microphone) for inputting a user's speech voice.

System State Grasping Unit 102

The system state grasping unit 102 is a data processing unit that recognizes the state of the system (information processing device 10). Specifically, the system state grasping unit 102 acquires external information of the information processing device 10 and internal information of the information processing device 10, generates “system state information” based on the acquired information, and outputs the “system state information” to the speech start keyword recognition unit 121.

The speech start keyword recognition unit 121 performs a process of assessing whether or not the user's speech is the speech start keyword by referring to the “system state information” input from the system state grasping unit 102.

Note that, in the configuration of the present disclosure, there are the following two types of speech start keywords.

(a) Default speech start keyword

(b) User registration speech start keyword

The (a) default speech start keyword is a keyword such as “Hi, Sony” described above with reference to FIG. 1.

When confirming that the user says the default speech start keyword, the keyword analysis unit 103 assesses that the user says the speech start keyword whatever system state the information processing device 10 is in.

The process of confirming the default speech start keyword performed by the keyword analysis unit 103 is executed on the basis of voice waveform information as described previously. In the speech confirmation process, a similarity assessment process is performed for assessing similarity between the voice waveform information of the default speech start keyword registered in the keyword analysis unit 103, for example, the voice waveform information of “Hi, Sony”, and the voice waveform of the input user's speech.

A threshold of a “recognition score”, which is a score indicating the similarity used in the similarity assessment process, is changed on the basis of external sound information (noise information) or the like included in the “system state information” input from the system state grasping unit 102.

An example of setting of the threshold will be described later.

On the other hand, (b) user registration speech start keyword is different from the default speech start keyword. When the user says the user registration speech start keyword, the keyword analysis unit 103 of the information processing device 10 performs a process of assessing whether or not the user's speech is the speech start keyword by referring to the “system state information” input from the system state grasping unit 102.

In the user registration speech start keyword assessment process, the similarity assessment process is also performed for assessing similarity between the voice waveform of the input user's speech and the voice waveform of the user registration speech start keyword which is registered in advance.

In this process, the threshold changing process based on the external sound information (noise information) or the like included in the “system state information” input from the system state grasping unit 102 is performed.

Further, each user registration speech start keyword is associated with information indicating in what system state the user's speech is assessed as the speech start keyword.

This correspondence information is stored in the user registration keyword holding unit 104.

When the user's speech is the user registration speech start keyword, the keyword analysis unit 103 of the information processing device 10 performs a process of assessing whether or not the user's speech is identified as the speech start keyword by referring to the “system state information” input from the system state grasping unit 102.

A specific example of processing will be described later.

As described above, the “system state information” generated by the system state grasping unit 102 includes the external information of the information processing device 10 and the internal information of the information processing device 10.

The external information includes, for example, time period, position (for example, GPS) information, external noise intensity information, and the like.

On the other hand, the internal information includes status information of an application controlled by the information processing device 10, for example, whether or not the application is being executed, the type of the executed application, setting information of the application, and the like.

The system state grasping unit 102 obtains these external information and internal information, generates “system state information” that can be used as auxiliary information in a speech start keyword selection process, and outputs the generated system state information to the speech start keyword recognition unit 121 of the keyword analysis unit 103.

As described previously, the keyword analysis unit 103 performs the speech confirmation process based on the voice waveform information. That is, the keyword analysis unit 103 performs the similarity assessment process for assessing the similarity between the voice waveform information of the speech start keyword that is registered in advance and the voice waveform of the input user's speech.

The threshold of the “recognition score”, which is the score indicating the similarity used in the similarity assessment process, can be changed on the basis of external sound information (noise information) or the like included in the “system state information” input from the system state grasping unit 102.

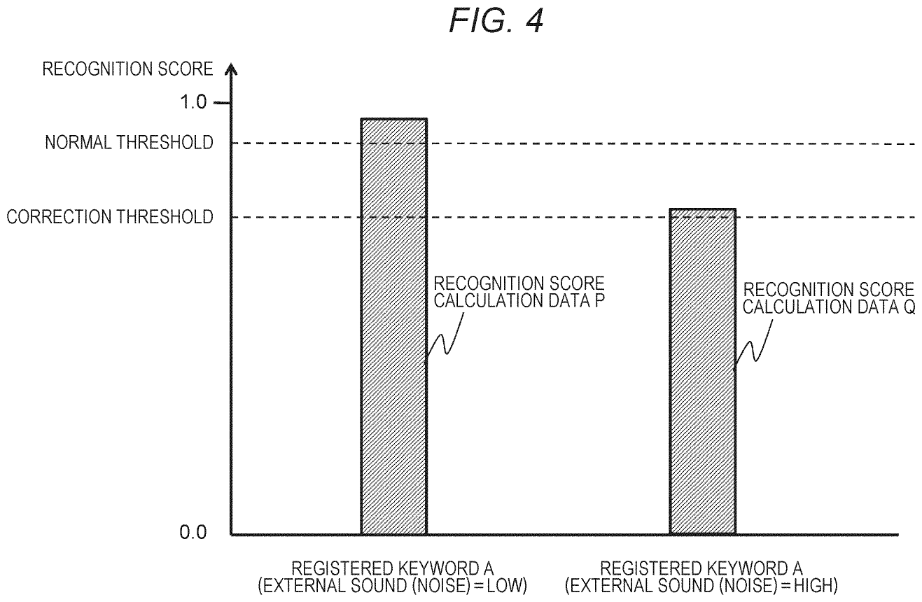

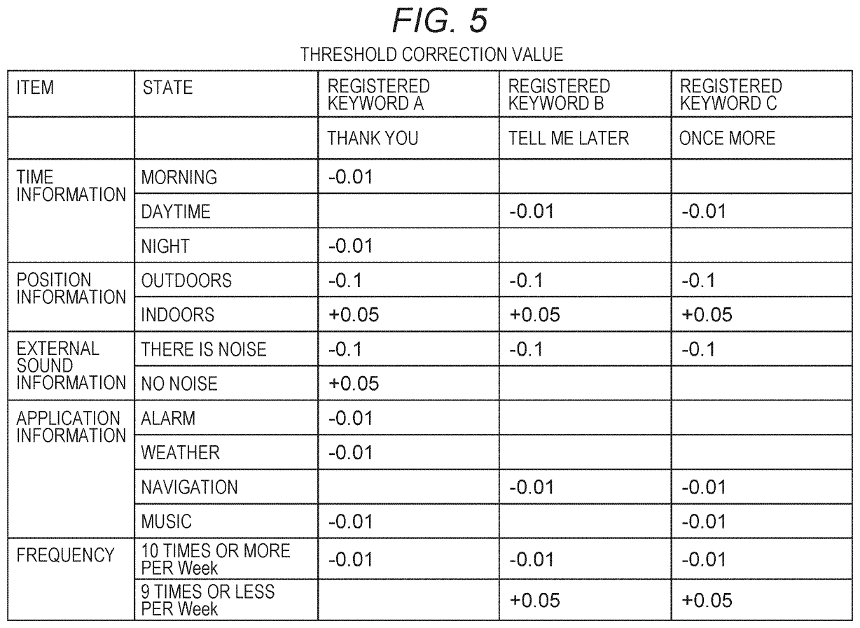

An example of setting of the threshold will be described with reference to FIGS. 4 and 5.

As one example, the “system state information” output from the system state grasping unit 102 to the keyword analysis unit 103 is used for a process of adjusting a threshold for the recognizability of the speech start keyword.

The threshold is a value set in response to a score corresponding to the similarity level between the voice waveform of the input user's speech and the voice waveform of the registered speech start keyword, that is, the “recognition score” indicating the speech start keyword likelihood of the input user's speech.

When assessing that the “recognition score” is equal to or greater than the threshold, the keyword analysis unit 103 assesses that the input user's speech is the speech start keyword, and when assessing that the “recognition score” is less than the threshold, the keyword analysis unit 103 assesses that the input user's speech is not the speech start keyword.

However, regarding the user registration speech start keyword, a process of assessing whether or not the user's speech is the speech start keyword is performed further on the basis of other system state information. A specific example of this processing will be described later.

FIG. 4 is a graph showing an example of the threshold set corresponding to the “recognition score” indicating the speech start keyword likelihood of the input user's speech.

The vertical axis represents the value of the “recognition score”, and the value of 1.0, for example, indicates that the similarity between the voice waveform of the input user's speech and the voice waveform of the registered speech start keyword is nearly 100%.

The graph of FIG. 4 shows a normal threshold and a correction threshold.

The normal threshold is applied when the external sound information (noise information) included in the “system state information” input from the system state grasping unit 102 is less than a predetermined noise threshold (external sound (noise)=low).

On the other hand, the correction threshold is applied when the external sound information (noise information) included in the “system state information” input from the system state grasping unit 102 is equal to or higher than the predetermined noise threshold (external sound (noise)=high).

FIG. 4 shows an example of recognition score calculation data for the same two registered keywords A.

Recognition score calculation data P is a recognition score calculated when the external sound information (noise information) included in the “system state information” input from the system state grasping unit 102 is less than the predetermined noise threshold (external sound (noise)=low).

Recognition score calculation data P has a recognition score of nearly 1.0 and exceeds the normal threshold. In this case, the keyword analysis unit 103 assesses that the input user's speech is the speech start keyword on the basis of the confirmation that the “recognition score” is greater than or equal to the normal threshold.

On the other hand, recognition score calculation data Q is a recognition score calculated when the external sound information (noise information) included in the “system state information” input from the system state grasping unit 102 is greater than or equal to the predetermined noise threshold (external sound (noise)=high).

Recognition score calculation data Q has a recognition score lower than the normal threshold, but exceeds the correction threshold. In this case, the keyword analysis unit 103 assesses that the input user's speech is the speech start keyword on the basis of the confirmation that the “recognition score” is greater than or equal to the correction threshold.

For example, when recognition score calculation data Q has a recognition score calculated when the external sound information (noise information) included in the “system state information” input from the system state grasping unit 102 is less than the predetermined noise threshold (external sound (noise)=low), the user's speech is not assessed to be the speech start keyword.

While the example of changing the threshold of the “recognition score” described with reference to FIG. 4 is an example using only the external sound information (noise information) included in the “system state information” input from the system state grasping unit 102, the threshold of the “recognition score” can be changed according to various other information as well as the external sound information (noise information) included in the “system state information”.

FIG. 5 shows correspondence data between the information included in the “system state information” input to the keyword analysis unit 103 from the system state grasping unit 102 and a threshold correction value of the “recognition score”.

As the threshold correction value of the “recognition score”, an individual value is set for each user registration keyword.

This correspondence data is stored in the memory in the keyword analysis unit 103 and can be changed by a user.

For example, in a case where the “system state information” received by the keyword analysis unit 103 from the system state grasping unit 102 has “time information=morning”, the threshold correction value of the “recognition score” for the user registration keyword A “Thank you” is set to −0.01.

This means that, in a case where the keyword analysis unit 103 performs the similarity assessment process for assessing the similarity with the registered keyword based on the voice waveform of the user registration keyword A “Thank you”, the assessment of whether or not the user's speech is the speech start keyword is performed by applying not the normal threshold but the correction threshold that is [normal threshold −0.01].

FIG. 5 shows the following information sets as the “system state information” received by the keyword analysis unit 103 from the system state grasping unit 102.

(1) Time information

(2) Position information

(3) External sound information

(4) Application information

(5) Frequency

FIG. 5 also shows the following three types of keywords as examples of the user registration keywords.

(A) Registered keyword A=(Thank you)

(B) Registered keyword B=(Tell me later)

(C) Registered keyword C=(Once more)

In a case where “(1) time information” in the “system state information” received from the system state grasping unit 102 indicates morning hours, the threshold for (A) registered keyword A=(Thank you) is lowered, and in a case where “(1) time information” indicates the daytime, the thresholds for (B) registered keyword B=(Tell me later) and (C) registered keyword C=(Once more) are lowered.

In this setting, the threshold in the time period in which the possibility of using each keyword is high is lowered so that the keyword is easily assessed as the start keyword in that time period.

In a case where “(2) position information” in the “system state information” input from the system state grasping unit 102 indicates outdoors, the thresholds for all of the registered keywords A to C are lowered, and in a case where it indicates indoors, the thresholds for all of the registered keywords A to C are raised.

This setting is made in consideration of the fact that the user's speech is easy to hear indoors and hard to hear outdoors.

In a case where “(3) external sound information” in the “system state information” input from the system state grasping unit 102 indicates that “there is noise”, the thresholds for all of the registered keywords A to C are lowered, and in a case where it indicates that “there is no noise”, the threshold for the registered keyword A is raised.

This is based on the following. When there is noise, the user's speech is hard to hear, and therefore, the thresholds are lowered. When there is no noise, (A) registered keyword A=“Thank you” is easier to hear than other user's speeches, so that the threshold therefor is raised.

Regarding “(4) application information” in the “system state information” input from the system state grasping unit 102, the threshold correction value is set for each type of application.

These applications are executed and controlled by the information processing device 10. However, the application program itself may be, for example, an application in the information processing device 10 or an application in, for example, an external server.

Regarding an alarm execution application, a weather information providing application, and a music information providing application, only the threshold for (A) registered keyword A=(Thank you) is lowered.

Regarding a navigation information providing application, the thresholds for (B) registered keyword B=(Tell me later) and (C) registered keyword C=(Once more) are lowered.

These thresholds can be freely set by the user and can be changed according to situations.

Regarding “(5) frequency” in the “system state information” input from the system state grasping unit 102, a threshold according to the frequency of input of the user's speech per week can be set, for example.

In a case where the number of user's speeches per week is large, for example, in a case where the user's speech is input 10 times or more per week, the threshold is lowered.

On the other hand, in a case where the number of user's speeches per week is small, for example, in a case where the user's speech is input 9 times or less per week, the threshold is raised.

The process of changing the thresholds described above is automatically executed by the keyword analysis unit 103 of the information processing device.

The keyword analysis unit 103 counts the input frequency of the user registration speech start keyword, determines a threshold correction value corresponding to each keyword according to the count result, and stores the determined threshold correction value in the memory in the keyword analysis unit 103 or the user registration keyword holding unit 104.

Next, the configuration and processing of the keyword analysis unit 103 of the information processing device 10 shown in FIG. 3 will be described.

Keyword Analysis Unit 103,

The keyword analysis unit 103 includes the speech start keyword recognition unit 121, the default speech start keyword processing unit 122, and the user registration speech start keyword processing unit 123.

These units will be sequentially described.

Speech Start Keyword Recognition Unit 121

The speech start keyword recognition unit 121 assesses whether or not the speech input to the voice input unit (microphone) 101 by the user is the speech start keyword. When assessing that the speech is not the speech start keyword, the speech start keyword recognition unit 121 requests the voice recognition unit 106 to perform the voice recognition process on the user's speech.

The assessment of whether or not the user's speech is the speech start keyword is actually executed by the default speech start keyword processing unit 122 or the user registration speech start keyword processing unit 123, and in this case, the processing is performed by these processing units.

The processing flow will be described.

When receiving the user's speech via the voice input unit (microphone) 101, the speech start keyword recognition unit 121 of the keyword analysis unit 103 firstly transfers the following two sets of information to the default speech start keyword processing unit 122 and the user registration speech start keyword processing unit 123.

(a) Voice signal of user's speech

(b) “System state information” input from system state grasping unit 101

The default speech start keyword processing unit 122 receives, from the speech start keyword recognition unit 121, the following information sets.

(a) Voice signal of user's speech

(b) “System state information” input from system state grasping unit 101

Then, the default speech start keyword processing unit 122 executes a recognition process of assessing whether or not the input user's speech is the default speech start keyword preset to the system (information processing device 10).

The default speech start keyword is a keyword such as “Hi, Sony” described previously with reference to FIG. 1.

When confirming that the user says the default speech start keyword, the keyword analysis unit 103 assesses that the user says the speech start keyword whatever system state the information processing device 10 is in.

The default speech start keyword processing unit 122 assesses whether or not the voice signal input to the voice input unit (microphone) 101 by the user is a voice signal corresponding to the speech start keyword registered in advance.

Note that this assessment process is executed simply on the basis of the voice waveform without performing the voice recognition process, that is, the process of converting the user's speech into text.

That is, the default speech start keyword processing unit 122 assesses the similarity between the voice waveform of the voice signal input to the voice input unit (microphone) 101 by the user and the voice waveform corresponding to the speech start keyword stored in a memory in the default speech start keyword processing unit 122, and assesses whether or not the user's speech is the speech start keyword registered in advance.

When assessing that the user's speech input to the system (information processing device 10) is the default speech start keyword, the default speech start keyword processing unit 122 outputs an internal state switching request to the internal state switching unit 109.

In response to the internal state switching request input from the default speech start keyword processing unit 122, the internal state switching unit 109 executes an internal state switching process for switching the state of the system (information processing device 10) from (a) speech awaiting stop state where the voice recognition process on the user's speech is not performed to (b) speech awaiting state where the voice recognition process on the user's speech is performed.

Next, the processing of the user registration speech start keyword processing unit 123 in the keyword analysis unit 103 will be described.

Similarly to the default speech start keyword processing unit 122, the user registration speech start keyword processing unit 123 also receives the following information sets from the speech start keyword recognition unit 121.

(a) Voice signal of user's speech

(b) “System state information” input from system state grasping unit 101

The user registration speech start keyword processing unit 123 assesses whether or not the voice signal input to the voice input unit (microphone) 101 by the user is the user registration speech start keyword registered in advance by the user.

Note that the user registration speech start keyword is stored in the user registration keyword holding unit 104.

First, the user registration speech start keyword processing unit 123 assesses whether or not the user's speech is the registered user registration speech start keyword on the basis of whether or not the voice signal input by the user to the voice input unit (microphone) 101 is similar to the voice signal of the user registration speech start keyword stored in the user registration keyword holding unit 104.

Further, the user registration speech start keyword processing unit 123 assesses whether or not the user's speech satisfies a registration condition registered in advance, and assesses that the user's speech is the user registration speech start keyword, only when the user's speech satisfies the registration condition.

It is to be noted that the registration condition indicates a condition registered in the user registration keyword holding unit 104 in association with the keyword. Specifically, the registration condition includes an application being executed in the information processing device 10, the input time and input timing of the user's speech, etc.

The user can register various speech start keywords into the user registration keyword holding unit 104 in association with various applications.

Further, the user registration keyword management unit 105 holds speech start keywords automatically collected by the system (the information processing device 10), and the user can store, into the user registration keyword holding unit 104, favorite keywords selected from the automatically collected speech start keywords as his or her own user registration speech start keywords.

A specific example of this processing will be described later.

As described above, the user registration speech start keyword processing unit 123 firstly assesses whether or not the voice signal input to the voice input unit (microphone) 101 by the user is the user registration speech start keyword registered in advance by the user.

Note that this assessment process is executed simply on the basis of the voice waveform without performing the voice recognition process, that is, the process of converting the user's speech into text.

That is, the user registration speech start keyword processing unit 123 assesses whether or not the user's speech is the user registration keyword registered in advance by assessing the similarity between the voice waveform of the voice signal input to the voice input unit (microphone) 101 by the user and the voice waveform corresponding to the user registration keyword stored in the user registration keyword holding unit 103.

The user registration speech start keyword processing unit 123 assesses that the user's speech is the user registration speech start keyword, when assessing that the voice signal input by the user to the voice input unit (microphone) 101 is similar to the user registration speech start keyword registered in advance by the user, and that the user's speech satisfies the registration condition registered in advance.

In this case, the user registration speech start keyword processing unit 123 outputs, to the semantic analysis unit 107, the keyword stored in the user registration keyword holding unit 103 and the information associated with the keyword.

User Registration Keyword Holding Unit 104

Next, the user registration keyword holding unit 104 will be described.

In the user registration keyword holding unit 104, a user registration speech start keyword (speech waveform information) is registered. The user can register various speech start keywords into the user registration keyword holding unit 104 in association with various applications.

Further, the user registration keyword holding unit 104 also stores keywords that are selected by the user from the speech start keywords, which are automatically collected by the system (information processing device 10) and which are stored in the user registration keyword management unit 105, and that are set as his or her own user registration speech start keywords.

The user can register the “execution content” indicating the process to be executed by the information processing device 10 in association with each of the user registration speech start keywords, in a case where the user registration speech start keyword processing unit 123 of the keyword analysis unit 103 assesses that the keyword is the speech start keyword.

Further, a condition for assessing that the keyword is the speech start keyword can also be registered in the user registration speech start keyword processing unit 123 in association with the keyword.

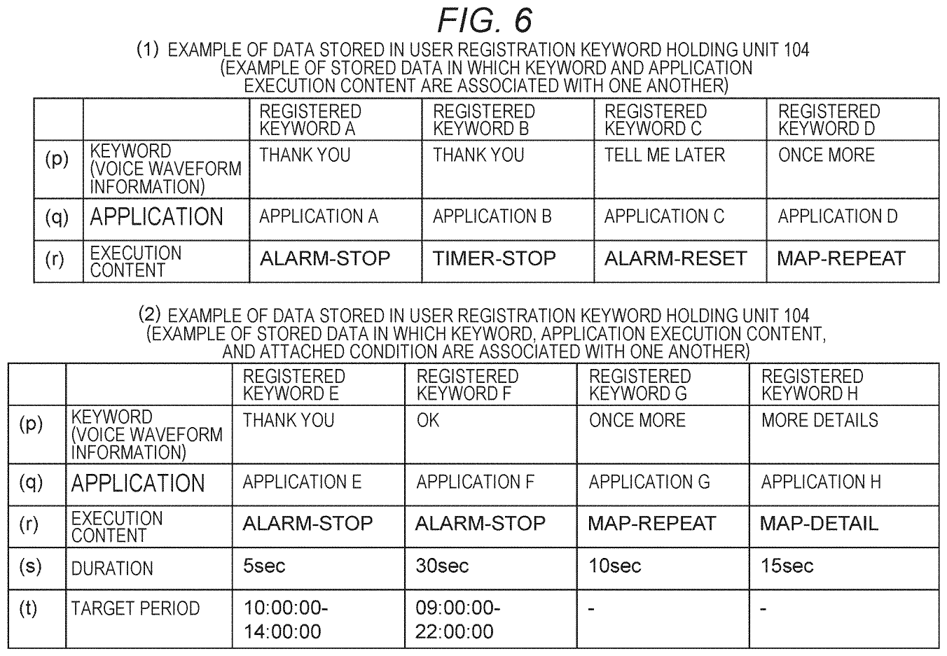

FIG. 6 is a diagram showing an example of data stored in the user registration keyword holding unit 104. FIG. 6 shows the following two examples of stored data.

(1) Example of stored data in which keyword, application, and application execution content are associated with one another

(2) Example of stored data in which keyword, application, application execution content, and attached condition are associated with one another

The example of stored data in which keyword, application, and application execution content are associated with one another shown in (1) of FIG. 6 indicates data in which the following data sets are associated with one another.

(p) User registration speech start keyword set by the user

(q) Application which are being executed by the information processing device 10 in order that the keyword is assessed as the speech start keyword

(r) Execution content information indicating execution content executed by the application controlled by the information processing device 10, in a case where the keyword is identified as a speech start keyword

For example, in the example shown in (1) of FIG. 6, the user registration speech start keyword A=(Thank you) is registered in association with the following data sets.

Application=Application A

Execution content information=ALARM-STOP

This indicates that, when the user registration speech start keyword processing unit 123 assesses that the user's speech “Thank you” is the user registration speech start keyword in a case where the application currently executed by the information processing device 10 is the application A, the information processing device 10 causes the application to execute an alarm stop process.

For example, when assessing that the user's speech “Thank you” is the user registration speech start keyword, the user registration speech start keyword processing unit 123 shown in FIG. 3 outputs the keyword stored in the user registration keyword holding unit 103 and the information associated with the keyword to the semantic analysis unit 107.

The semantic analysis unit 107 executes the semantic analysis of the user's speech on the basis of these information sets, and outputs the analysis result to the operation command issuing unit 108.

For example, the semantic analysis unit 107 analyzes that the user's speech “Thank you” means an alarm stop request, and outputs, to the operation command issuing unit 108, information indicating that the alarm stop request is issued from the user as the analysis result.

The operation command issuing unit 108 outputs this operation command to the application currently running in the information processing device 10. Specifically, the operation command issuing unit 108 issues an alarm stop request to the application.

In the example shown in (1) of FIG. 6, the user registration speech start keyword B=(Thank you) is registered in association with the following data sets.

Application=Application B

Execution content information=TIMER-STOP

The user registration speech start keywords A and B are both “Thank you” which is the user's speech, but the execution contents of the keywords A and B are different from each other.

This means that the execution content differs depending on the application being executed in the information processing device 10.

The user registration speech start keyword processing unit 123 receives the “system state information” from the system state grasping unit 102, and assesses whether or not the user's speech is the user registration speech start keyword according to the input information.

The “system state information” input from the system state grasping unit 102 includes application information regarding an application being executed in the information processing device 10.

According to this application information, the user registration speech start keyword processing unit 123 selects one data from the data sets stored in the user registration keyword holding unit 104 and performs processing.

When the user registration speech start keyword processing unit 123 assesses that the user's speech is the user registration speech start keyword in a case where the application currently executed by the information processing device 10 is the application B, the information processing device 10 causes the application to execute a timer stop process.

Further, there is also (2) a setting of storing data in which keyword, application, application execution content, and attached condition are associated with one another as shown in (2) of FIG. 6.

As the attached condition, a duration and target period are recorded.

The duration indicates a duration of the process of assessing whether or not the user's speech is the speech start keyword by the user registration speech start keyword processing unit 123, and is also an elapsed time from the timing at which the application associated with the registered keyword executes a certain process (including a state change).

The target period is a time period in which the user registration speech start keyword processing unit 123 performs a process of assessing whether or not the user's speech is the speech start keyword.

Outside the target period, the user registration speech start keyword processing unit 123 does not perform the process of assessing whether or not the user's speech is the speech start keyword for the registered keyword. Therefore, the system (information processing device 10) does not recognize the user's speech as the speech start keyword.

Note that the duration is set in advance to a prescribed value (default value) such as 10 seconds. However, this value can be changed by the user.

Similarly, the target period can also be freely set by the user.

For example, in the example shown in (2) of FIG. 6, the user registration speech start keyword E=(Thank you) is registered in association with the following data sets.

Application=Application E

Execution content information=ALARM-STOP

Duration=5 sec

Target period=10:00-14:00

This indicates that, when the user registration speech start keyword processing unit 123 assesses that the user's speech “Thank you” is the user registration speech start keyword in a case where: the user says this word during the target period of 10:00-14:00; the application currently executed by the information processing device 10 is the application E; and the elapsed time from when the application E executes a certain process (including a state change) is within 5 seconds, the information processing device 10 causes the application to execute an alarm stop process.

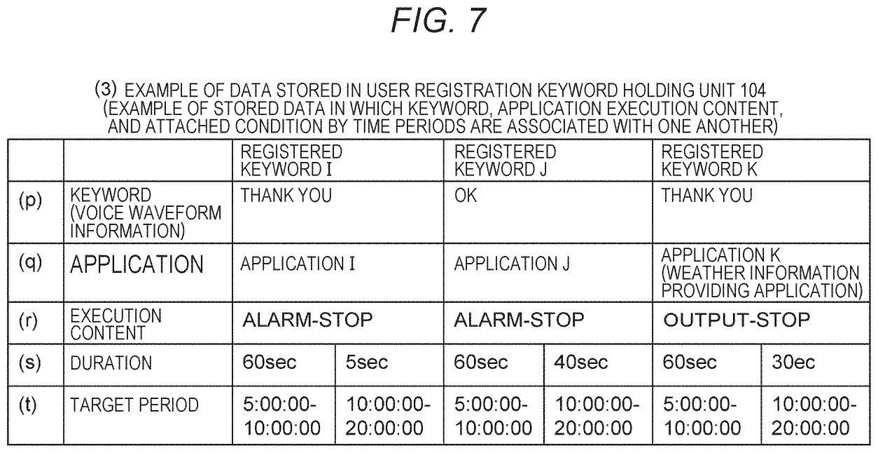

Further, there is also (3) a setting of storing data in which keyword, application, application execution content, and attached condition by time periods are associated with one another as shown in (3) of FIG. 7.

As the attached condition, a duration and target period are recorded as described with reference to (2) of FIG. 6, but the attached condition can be set such that different durations are set for each time period.

Specifically, the target period, which is a time period in which the user registration speech start keyword processing unit 123 performs a process of assessing whether or not the user's speech is the speech start keyword, includes a plurality of target periods, and different durations are set for the target periods.

For example, in the example shown in FIG. 7, the user registration speech start keyword I=(Thank you) is registered in association with the following data sets.

Application=Application I

Execution content information=ALARM-STOP

(a) Target period=5:00-10:00/Duration=60 sec

(b) Target period=10:00-20:00/Duration=5 sec

This indicates that, when the user registration speech start keyword processing unit 123 assesses that the user's speech “Thank you” is the user registration speech start keyword in a case where the following conditions are satisfied that: the user says this word during the target period which is 5:00-10:00; the application currently executed by the information processing device 10 is the application I; and the elapsed time from when the application I executes a certain process (including a state change) is within 60 seconds, the information processing device 10 causes the application to execute an alarm stop process.

On the other hand, in a case where the user's speech “Thank you” is issued during the target period of 10:00-20:00, this user's speech is assessed as the user registration speech start keyword, and the alarm stop process is executed, only when the elapsed time is within 5 seconds.

In this way, the duration can be set differently for each time period.

Note that, in the examples of data stored in the user registration keyword holding unit 104 described with reference to FIGS. 6 and 7, application information is associated with the user registration speech start keyword. In place of the configuration in which the user registration speech start keyword is recorded in association with application information, application information may not be recorded. In this case, the information processing device 10 executes all the execution contents, corresponding to the keyword, registered in the user registration keyword holding unit 104 corresponding to the user's speech. Alternatively, an application control unit may select an application whose registered execution content is executable and execute the selected application.

Note that the application control unit can be provided inside or outside the information processing device 10. For example, the application control unit includes an operation command issuing unit 108 having information of a device controllable by the information processing device 10 or a module that receives a command from the operation command issuing unit 108 and transmits a signal to an operation device.

User Registration Keyword Management Unit 105

Next, the user registration keyword management unit 105 in the information processing device 10 shown in FIG. 3 will be described.

The user registration keyword management unit 105 holds speech start keywords automatically collected by the system (the information processing device 10), and the user can store, into the user registration keyword holding unit 104, favorite keywords selected from the automatically collected speech start keywords as his or her own user registration speech start keywords.

The user registration keyword management unit 105 acquires and stores information regarding speech start keywords used by various other users via, for example, a network to which the system (information processing device 10) is connected.

The collected keywords are held together with execution contents of applications and proportions of user groups for each type of information such as age, gender, area, preference, etc. of each user.

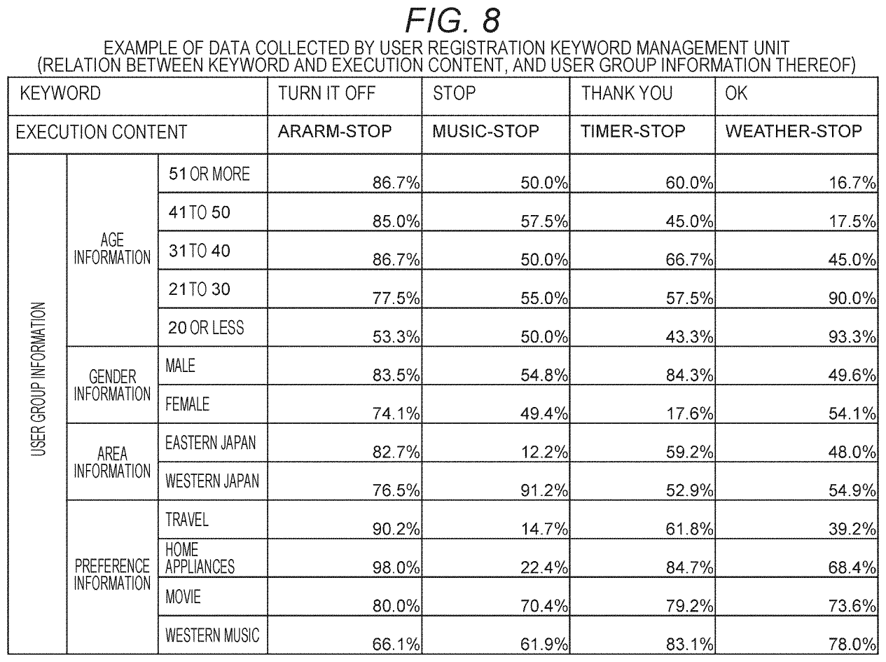

FIG. 8 shows an example of collected information collected and held by the user registration keyword management unit 105.

The example shown in FIG. 8 shows data having recorded therein the relationship between the user registration keyword and the execution content, user group information, and a usage rate (%) of each keyword used by a user belonging to each user group, in association with one another.

The user group information includes age information, gender information, area information, and preference information of users who use each user registration keyword.

As the preference information, prediction data based on each user's behavior log, application usage frequency, etc. is acquired. The system (information processing device 10) can present such information to the user as it is. Alternatively, the system can generate data having only information corresponding to specific users due to some degree of clustering and present such data to the user.

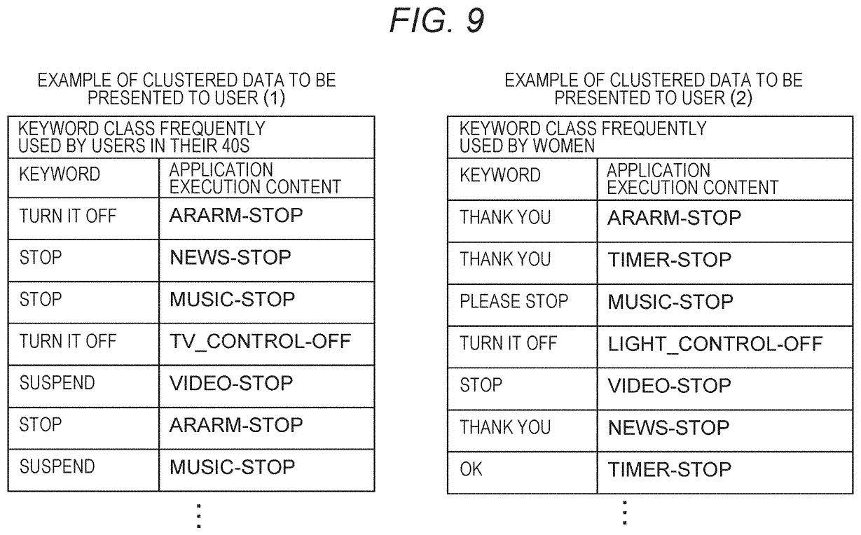

FIG. 9 shows an example of limited clustered data.

FIG. 9 shows an example of clustered data for two different documents.

Part (1) indicates aggregate data of user registration speech start keywords that are frequently used by users in their 40 s.

Part (2) indicates aggregate data of user registration speech start keywords that are frequently used by women.

The user can select his/her favorite keyword by referring to, for example, user registration speech start keywords used by other users shown in FIGS. 8 and 9, and can copy and store the selected keyword into the user registration keyword holding unit 104 as his/her own user registration speech start keyword.

Alternatively, the user may select his/her favorite keyword by referring to, for example, user registration speech start keywords used by other users shown in FIGS. 8 and 9, set ON/OFF of the function he/she intends to use, and cause the user registration speech start keyword processing unit 123 to read the data having ON setting and to execute a process similar to the process for data stored in the user registration keyword holding unit 104.

Next, the processing executed by the units from the voice recognition unit 106 to the internal state switching unit 109 in the information processing device shown in FIG. 3 will be sequentially described.

Voice Recognition Unit 106

The voice recognition unit 106 executes a voice recognition process of converting the voice waveform of the user's speech input from the voice input unit (microphone) 101 into a character string.

The voice recognition unit 106 also has a signal processing function of reducing ambient sound such as noise, for example.

It is to be noted that, as described previously, the process related to the speech start keyword, that is, the assessment of whether or not the user's speech is the speech start keyword, is executed as the process based on the voice waveform in the keyword analysis unit 103, and thus the voice recognition process is not performed.

The speech start keyword recognition unit 121 in the keyword analysis unit 103 assesses whether or not the speech input to the voice input unit (microphone) 101 by the user is the speech start keyword. When assessing that the speech is not the speech start keyword, the speech start keyword recognition unit 121 requests the voice recognition unit 106 to perform the voice recognition process on the user's speech.

The voice recognition unit 106 performs the voice recognition process in response to the processing request.

The voice recognition unit 106 converts the voice waveform of the user's speech input from the voice input unit (microphone) 101 into a character string, and outputs information regarding the converted character string to the semantic analysis unit 107.

It is to be noted that, as will be described in detail later, when the information processing device 10 is not in a user's speech acceptable state, the speech start keyword recognition unit 121 of the keyword analysis unit 103 does not issue a voice recognition processing request to the voice recognition unit 106. Alternatively, the voice recognition unit 106 may not perform the voice recognition process even if a request is input.

Semantic Analysis Unit 107

The semantic analysis unit 107 estimates a semantic system and a semantic expression that the system (information processing device 10) can process the character string input from the voice recognition unit 106. The semantic system and the semantic expression are expressed in the form of “operation command” that the user intends to execute and “attached information” that is a parameter thereof.

The “operation command” generated by the semantic analysis unit 107 and the “attached information” that is a parameter thereof are output to the operation command issuing unit 108.

A plurality of attached information sets may be applied to one operation command, and the result of the semantic analysis is output as one or a plurality of sets. (Input: “Set alarm at 8”, “Operation command”: ALARM-SET, “Attached information”: “8:00”, etc.)

It is to be noted that, as described previously, when assessing that the voice signal input to the voice input unit (microphone) 101 by the user is the user registration speech start keyword registered in advance by the user, the user registration speech start keyword processing unit 123 outputs the keyword stored in the user registration keyword holding unit 103 and the information (information stored in the user registration keyword holding unit 104) associated with the keyword to the semantic analysis unit 107.

When receiving the keyword and information associated with the keyword (information stored in the user registration keyword holding unit 104) from the user registration speech start keyword processing unit 123, the semantic analysis unit 107 generates a semantic analysis result of the user's speech using this information, and outputs the result to the operation command issuing unit 108.

Operation Command Issuing Unit 108

The operation command issuing unit 108 outputs an execution command of the process to be executed by the system (information processing device 10) to a process execution unit on the basis of the semantic analysis result corresponding to the user's speech generated by the semantic analysis unit 107, that is, the “operation command”, and the “attached information” which is a parameter thereof.

Although the process execution unit is not shown in FIG. 3, it is specifically achieved by, for example, a data processing unit such as a CPU having an application execution function.

The process execution unit also has a communication unit and the like for requesting processing to an external application execution server and acquiring the processing result.

Further, the operation command issuing unit 108 outputs an internal state switching request to the internal state switching unit 109 after issuing the operation command.

The state of the system (information processing device 10) is either of the following two states:

(a) Speech awaiting stop state in which voice recognition process is not performed on user's speech; and

(b) Speech awaiting state in which voice recognition process is performed on user's speech.

When the operation command issuing unit 108 issues the operation command, the information processing device 10 is in (b) the speech awaiting state in which the voice recognition process is performed on the user's speech. Therefore, the operation command issuing unit 108 outputs, to the internal state switching unit 109, the internal state switching request for changing the state to (a) the speech awaiting stop state in which voice recognition process is not performed on the user's speech.

Internal State Switching Unit 109

The internal state switching unit 109 performs a process of switching the state of the system (information processing device 10) between the following two states:

(a) Speech awaiting stop state in which voice recognition process is not performed on user's speech;

(b) Speech awaiting state in which voice recognition process is performed on user's speech.

Specifically, after the operation command issuing unit 108 issues an operation command, the internal state switching unit 109 changes the state from (b) the speech awaiting state in which the voice recognition process is performed on the user's speech to (a) the speech awaiting stop state in which the voice recognition process is not performed on the user's speech, in response to the request from the operation command issuing unit 108.

Further, in response to an input of the internal state switching request from the default speech start keyword processing unit 122, the internal state switching unit 109 executes an internal state switching process for switching the state of the system from (a) the speech awaiting stop state where the voice recognition process is not performed on the user's speech to (b) the speech awaiting state where the voice recognition process is performed on the user's speech.

### 3. Specific Examples of Processing Executed by Information Processing Device

Next, specific examples of processing executed by the information processing device will be described.

A plurality of examples of processing will be sequentially described.

### Processing Example 1

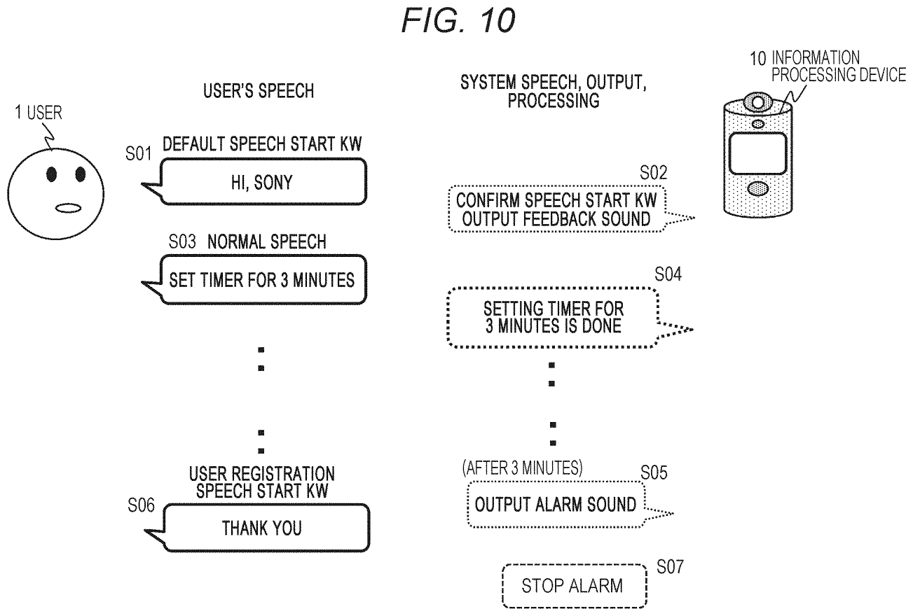

First, processing example 1 will be described with reference to FIG. 10.

In FIG. 10, the speech of the user 1 is shown on the left side, and the system speech, output, and processing executed by the system (information processing device 10) are shown on the right side.

Note that the user's speech is categorized into three as follows.

(a) Default speech start keyword (KW)

(b) User registration speech start keyword (KW)

(c) Normal speech (other than (a) and (b) above)

(a) Default speech start keyword (KW)

(b) User registration speech start keyword (KW)

These user's speeches are speeches assessed to be (a) default speech start keyword (KW) or (b) user registration speech start keyword (KW) on the basis of the voice waveform by the keyword analysis unit 103 shown in FIG. 3, and they are not subjected to the voice recognition process (not converted into text).

When receiving (a) default speech start keyword (KW) from the user, the system (information processing device 10) outputs a confirmation sound (feedback sound) indicating that the input of the default speech start keyword (KW) has been confirmed. Then, the system makes settings to receive the subsequent user's speech (normal speech) and start voice recognition.

Further, when assessing that (b) user registration speech start keyword (KW) is input, the system performs semantic analysis according to the information input from the user registration speech start keyword processing unit 123, that is, the information registered to the user registration keyword holding unit 104, and executes processing according to the semantic analysis result.

(c) Normal speech (other than (a) and (b) above) is a user's speech which is assessed not to be the speech start keyword by the keyword analysis unit 103 shown in FIG. 3. Therefore, (c) normal speech is subjected to the voice recognition process (converted into text) and semantic analysis process, and the system (information processing device 10) performs processing based on the results of these processes. It is to be noted that, as described previously, in a case where the information processing device 10 is not in the user's speech acceptable state, the voice recognition unit 106 does not perform the voice recognition process (conversion into text) and the semantic analysis process.

The processing proceeds in sequence from step S01 shown in FIG. 10. The process of each step will be sequentially described.

(Step S01)

First, in step S01, the user says the following default speech start keyword.

User's speech=Hi, Sony

(Step S02)

The information processing device 10 assesses, in the default speech start keyword processing unit 122 of the keyword analysis unit 103, that the user's speech in step S01 is the default speech start keyword.

In step S02, the information processing device 10 outputs a confirmation sound (feedback sound) indicating that the device has confirmed the default speech start keyword “Hi, Sony” input by the user on the basis of the assessment. Further, the information processing device 10 makes settings to receive the subsequent user's speech (normal speech) and start voice recognition.

(Step S03)

Next, the user says the following normal speech in step S03.

User's speech=Set timer for 3 minutes

(Step S04)

Next, in step S04, the information processing device 10 performs a process and makes a response based on the result of voice recognition and semantic analysis on the user's speech in step S03. Specifically, the information processing device 10 performs a process of setting a timer for 3 minutes, and outputs the following system speech.

System speech=Setting timer for 3 minutes is done

(Step S05)

The information processing device 10 outputs an alarm sound in step S05, which is three minutes after the device issues the system speech in step S04.

(Step S06)

Next, in step S06, the user says the following user registration speech start keyword.

User's speech=Thank you

This user's speech corresponds to the user registration keyword A shown in FIG. 6.

(Step S07)

The information processing device 10 assesses, in the user registration speech start keyword processing unit 123 of the keyword analysis unit 103, that the user's speech in step S06 is the user registration speech start keyword. Further, the information processing device 10 outputs the registration information (keyword, execution content, etc.) in the user registration keyword holding unit 104 to the semantic analysis unit 107.

The semantic analysis unit 107 performs semantic analysis on the user's speech based on this input information, and outputs a processing request according to the analysis result to the operation command issuing unit 108. The operation command issuing unit 108 causes the application execution unit to execute the process.

In the example shown in FIG. 10, a process of stopping the alarm is performed in step S07.

This indicates that the keyword “Thank you” and execution content “ALARM-STOP” are registered as the registration information (keyword, execution content, etc.) in the user registration keyword holding unit 104 in association with the application being executed.

This corresponds to the registration information of the registered keyword A shown in FIG. 6.

As described above, when the user sets a timer and an alarm is output by the timer, the user only needs to say “Thank you” (the user registration speech start keyword). With this process, the system (information processing device 10) receives the speech, and can perform an action of stopping the alarm in accordance with the execution content information associated with the user registration speech start keyword.

### Processing Example 2

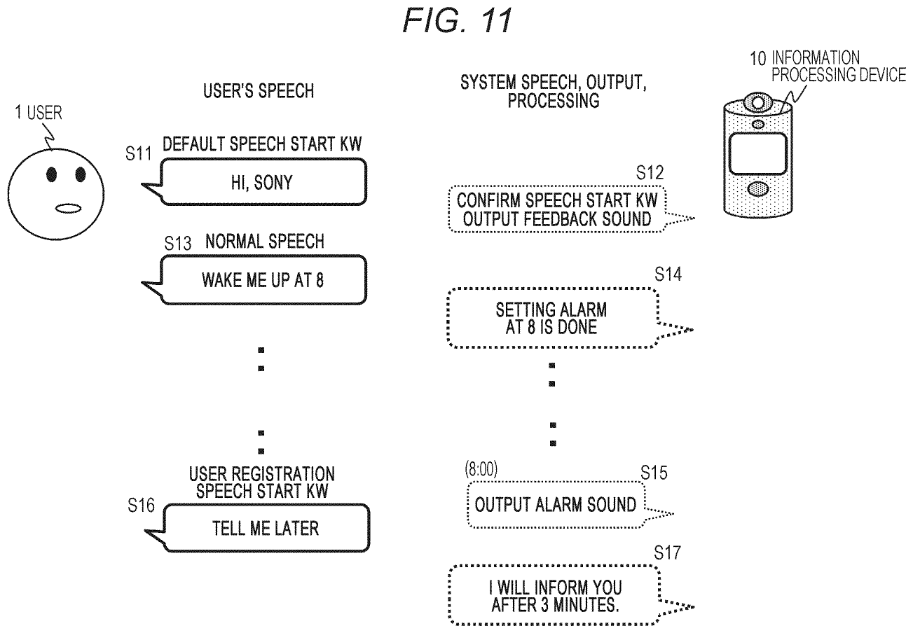

Next, processing example 2 will be described with reference to FIG. 11.

(Step S11)

First, in step S11, the user says the following default speech start keyword.

User's speech=Hi, Sony

(Step S12)

The information processing device 10 assesses, in the default speech start keyword processing unit 122 of the keyword analysis unit 103, that the user's speech in step S11 is the default speech start keyword.

In step S12, the information processing device 10 outputs a confirmation sound (feedback sound) indicating that the device has confirmed the default speech start keyword “Hi, Sony” input by the user on the basis of the assessment. Further, the information processing device 10 makes settings to receive the subsequent user's speech (normal speech) and start voice recognition.

(Step S13)

Next, the user says the following normal speech in step S13.

User's speech=Wake me up at 8

(Step S14)

Next, in step S14, the information processing device 10 performs a process and makes a response based on the result of voice recognition and semantic analysis on the user's speech in step S13. Specifically, the information processing device 10 performs a process of setting an alarm at 8, and outputs the following system speech.

System speech=Setting alarm at 8 is done.

(Step S15)

The process of step S15 is a process performed at 8:00 which is the alarm setting time.

The information processing device 10 outputs an alarm sound in step S15.

(Step S16)

Next, in step S16, the user says the following user registration speech start keyword.

User's speech=Tell me later

This user's speech corresponds to the user registration keyword C shown in FIG. 6.

(Step S17)

The information processing device 10 assesses, in the user registration speech start keyword processing unit 123 of the keyword analysis unit 103, that the user's speech in step S16 is the user registration speech start keyword. Further, the information processing device 10 outputs the registration information (keyword, execution content, etc.) in the user registration keyword holding unit 104 to the semantic analysis unit 107.

The semantic analysis unit 107 performs semantic analysis on the user's speech based on this input information, and outputs a processing request according to the analysis result to the operation command issuing unit 108. The operation command issuing unit 108 causes the application execution unit to execute the process.

In the example shown in FIG. 11, in step S17, an alarm reset process is performed, and further, the following system speech is output.

System speech=I will inform you after 3 minutes.

This indicates that the keyword “Thank you” and execution content “ALARM-RESET” are registered as the registration information (keyword, execution content, etc.) in the user registration keyword holding unit 104 in association with the application being executed.

This corresponds to the registration information of the registered keyword C shown in FIG. 6.

In this example, the user sets an alarm, and the information processing device 10 outputs the alarm at the set time. When the set time comes, the information processing device 10 outputs an alarm, and the user can immediately reset the alarm by saying the user registration speech start keyword “Tell me later”.

Note that, regarding the process for the expression “later”, the information processing device 10 uses a default set time which is a value preset in the application (alarm application), for example, “3 minutes” or the like.

This set time can be changed by the user.

### Processing Example 3

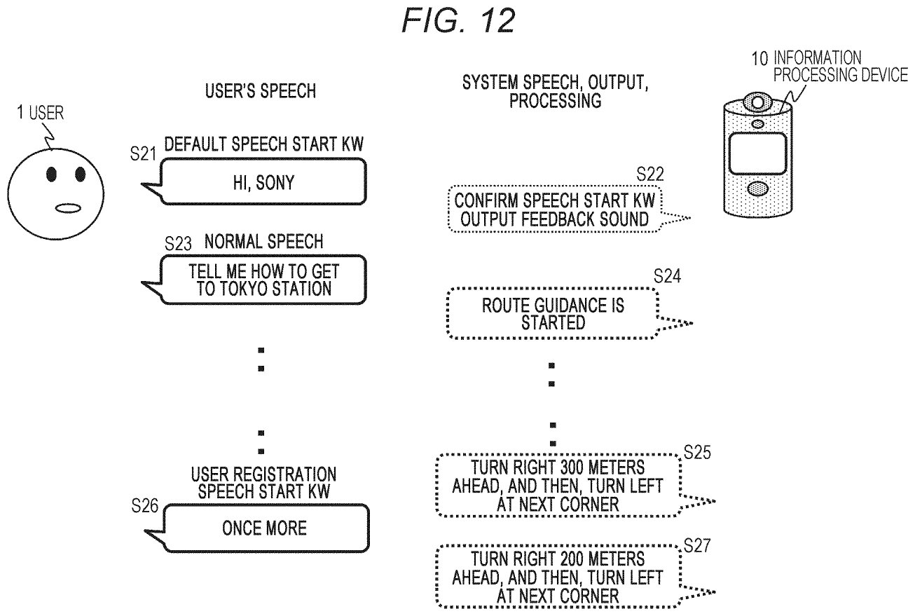

Next, processing example 3 will be described with reference to FIG. 12.

(Step S21)

First, in step S21, the user says the following default speech start keyword.

User's speech=Hi, Sony

(Step S22)

The information processing device 10 assesses, in the default speech start keyword processing unit 122 of the keyword analysis unit 103, that the user's speech in step S21 is the default speech start keyword.

In step S22, the information processing device 10 outputs a confirmation sound (feedback sound) indicating that the device has confirmed the default speech start keyword “Hi, Sony” input by the user on the basis of the assessment. Further, the information processing device 10 makes settings to receive the subsequent user's speech (normal speech) and start voice recognition.

(Step S23)

Next, the user says the following normal speech in step S23.

User's speech=Tell me how to get to Tokyo Station

(Step S24)

Next, in step S24, the information processing device 10 performs a process and makes a response based on the result of voice recognition and semantic analysis on the user's speech in step S23. Specifically, for example, the information processing device 10 starts a navigation application, and outputs the following system speech.

System speech=Route guidance is started.

(Step S25)

The process of step S25 is a process performed when the user approaches the destination.

The information processing device 10 outputs the following system speech in step S25.

System speech=Turn right 300 meters ahead, and then, turn left at next corner

(Step S26)

Next, in step S26, the user says the following user registration speech start keyword.

User's speech=Once more

This user's speech corresponds to the user registration keyword D shown in FIG. 6.

(Step S27)

The information processing device 10 assesses, in the user registration speech start keyword processing unit 123 of the keyword analysis unit 103, that the user's speech in step S26 is the user registration speech start keyword. Further, the information processing device 10 outputs the registration information (keyword, execution content, etc.) in the user registration keyword holding unit 104 to the semantic analysis unit 107.

The semantic analysis unit 107 performs semantic analysis on the user's speech based on this input information, and outputs a processing request according to the analysis result to the operation command issuing unit 108. The operation command issuing unit 108 causes the application execution unit to execute the process.

In the example shown in FIG. 12, the information processing device 10 repeatedly outputs the navigation information in step S27.

Specifically, the information processing device 10 outputs the following system speech.

System speech=Turn right 200 meters ahead, and then, turn left at next corner

This indicates that the keyword “Once more” and execution content “MAP-REPEAT” are registered as the registration information (keyword, execution content, etc.) in the user registration keyword holding unit 104 in association with the application being executed.

This corresponds to the registration information of the registered keyword D shown in FIG. 6.

### Processing Example 4

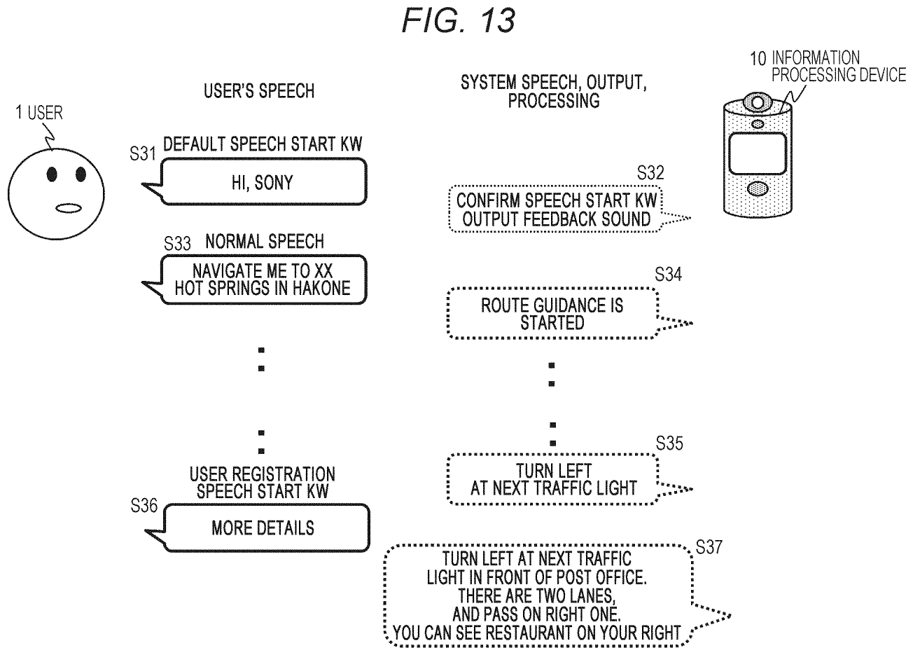

Next, processing example 4 will be described with reference to FIG. 13.

(Step S31)

First, in step S31, the user says the following default speech start keyword.

User's speech=Hi, Sony

(Step S32)

The information processing device 10 assesses, in the default speech start keyword processing unit 122 of the keyword analysis unit 103, that the user's speech in step S31 is the default speech start keyword.

In step S32, the information processing device 10 outputs a confirmation sound (feedback sound) indicating that the device has confirmed the default speech start keyword “Hi, Sony” input by the user on the basis of the assessment. Further, the information processing device 10 makes settings to receive the subsequent user's speech (normal speech) and start voice recognition.

(Step S33)

Next, the user says the following normal speech in step S33.

User's speech=Navigate me to XX hot springs in Hakone

(Step S34)

Next, in step S34, the information processing device 10 performs a process and makes a response based on the result of voice recognition and semantic analysis on the user's speech in step S33. Specifically, for example, the information processing device 10 starts a navigation application, and outputs the following system speech.

System speech=Route guidance is started.

(Step S35)

The process of step S35 is a process performed when the user approaches the destination.

The information processing device 10 outputs the following system speech in step S35.

System speech=Turn left at next traffic light

(Step S36)

Next, in step S36, the user says the following user registration speech start keyword.

User's speech=More details

This user's speech corresponds to the user registration keyword H shown in FIG. 6.

(Step S37)

The information processing device 10 assesses, in the user registration speech start keyword processing unit 123 of the keyword analysis unit 103, that the user's speech in step S36 is the user registration speech start keyword. Further, the information processing device 10 outputs the registration information (keyword, execution content, etc.) in the user registration keyword holding unit 104 to the semantic analysis unit 107.

The semantic analysis unit 107 performs semantic analysis on the user's speech based on this input information, and outputs a processing request according to the analysis result to the operation command issuing unit 108. The operation command issuing unit 108 causes the application execution unit to execute the process.

In the example shown in FIG. 13, the information processing device 10 outputs the navigation information in detail in step S37.

Specifically, the information processing device 10 outputs the following system speech.

System speech=Turn left at next traffic light in front of post office. There are two lanes, and pass on right one. You can see a restaurant on your right.

This indicates that the keyword “Once more” and execution content “MAP-DETAIL” are registered as the registration information (keyword, execution content, etc.) in the user registration keyword holding unit 104 in association with the application being executed.

This corresponds to the registration information of the registered keyword H shown in FIG. 6.

The processing examples 3 and 4 described with reference to FIGS. 12 and 13 show processing using a navigation application. In response to the feedback from the information processing device 10, the user inputs a speech requesting repeat or detailed explanation, such as “Once more” or “More details”, as the user registration speech start keyword, and with this process, the information processing device 10 can quickly make a response according to the user request.

### Processing Example 5

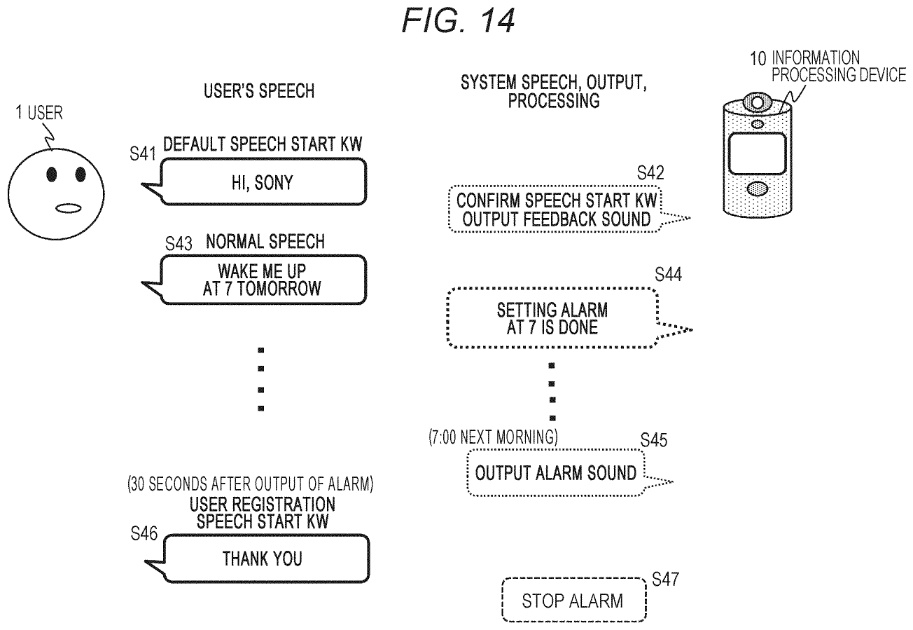

Next, processing example 5 will be described with reference to FIG. 14.

(Step S41)

First, in step S41, the user says the following default speech start keyword.

User's speech=Hi, Sony

(Step S42)

The information processing device 10 assesses, in the default speech start keyword processing unit 122 of the keyword analysis unit 103, that the user's speech in step S41 is the default speech start keyword.

In step S42, the information processing device 10 outputs a confirmation sound (feedback sound) indicating that the device has confirmed the default speech start keyword “Hi, Sony” input by the user on the basis of the assessment. Further, the information processing device 10 makes settings to receive the subsequent user's speech (normal speech) and start voice recognition.

(Step S43)

Next, the user says the following normal speech in step S43.

User's speech=Wake me up at 7 tomorrow

(Step S44)

Next, in step S44, the information processing device 10 performs a process and makes a response based on the result of voice recognition and semantic analysis on the user's speech in step S43. Specifically, the information processing device 10 performs a process of setting an alarm at 7:00, and outputs the following system speech.

System speech=Setting alarm at 7 is done.

(Step S45)

The process of step S45 is a process performed at 7:00 next morning which is the alarm setting time.

The information processing device 10 outputs an alarm sound in step S45.

(Step S46)

Next, in step S46, the user says the following user registration speech start keyword 30 minutes after the output of the alarm.

User's speech=Thank you

This user's speech corresponds to the user registration keyword I shown in FIG. 7.

(Step S47)

The information processing device 10 assesses, in the user registration speech start keyword processing unit 123 of the keyword analysis unit 103, that the user's speech in step S46 is the user registration speech start keyword. Further, the information processing device 10 outputs the registration information (keyword, execution content, etc.) in the user registration keyword holding unit 104 to the semantic analysis unit 107.

The semantic analysis unit 107 performs semantic analysis on the user's speech based on this input information, and outputs a processing request according to the analysis result to the operation command issuing unit 108. The operation command issuing unit 108 causes the application execution unit to execute the process.

In the example shown in FIG. 14, a process of stopping the alarm is performed in step S47.

This example shows the processing using the user registration speech start keyword I shown in FIG. 7 for causing the information processing device 10 to execute the process of stopping the alarm which has been set so that the user could wake up in the morning. The user registration speech start keyword I is associated with (a) target period=5:00-10:00/duration=60 sec, and (b) target period=10:00-20:00/duration=5 sec. In the present example, the duration at 7:00 when the alarm is output is 60 sec. Therefore, the information processing device 10 assesses the user's speech issued 30 minutes after the alarm output as the user registration speech start keyword, and performs the process of stopping the alarm.

Note that, regarding a user registration speech start keyword to which the duration is not set, it is preferable to set a predetermined maximum allowable duration such as, for example, duration=3 minutes.

### Processing Example 6

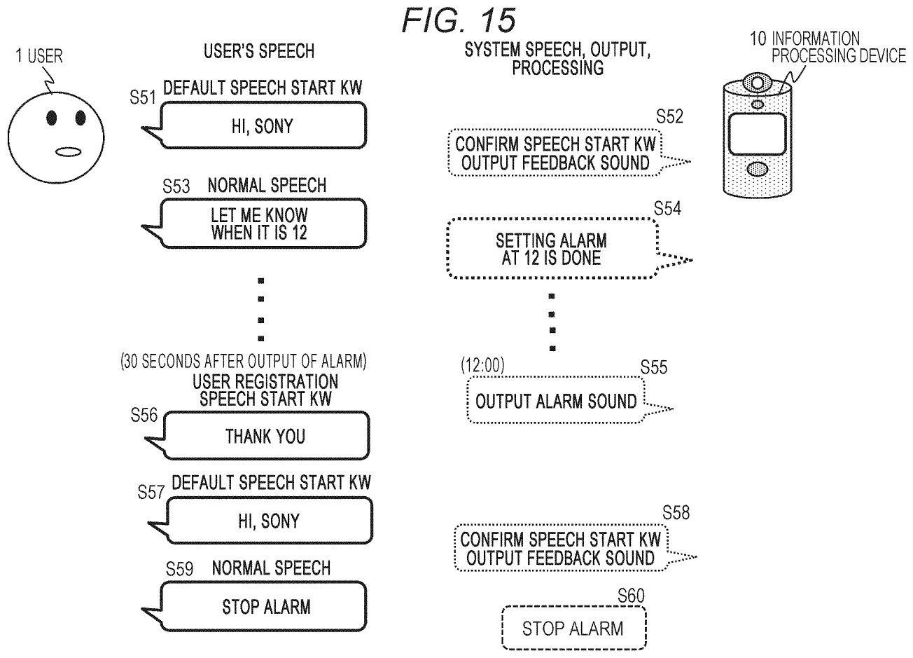

Next, processing example 6 will be described with reference to FIG. 15.

(Step S51)

First, in step S51, the user says the following default speech start keyword.

User's speech=Hi, Sony

(Step S52)

The information processing device 10 assesses, in the default speech start keyword processing unit 122 of the keyword analysis unit 103, that the user's speech in step S51 is the default speech start keyword.

In step S52, the information processing device 10 outputs a confirmation sound (feedback sound) indicating that the device has confirmed the default speech start keyword “Hi, Sony” input by the user on the basis of the assessment. Further, the information processing device 10 makes settings to receive the subsequent user's speech (normal speech) and start voice recognition.

(Step S53)

Next, the user says the following normal speech in step S53.

User's speech=Let me know when it is 12

(Step S54)

Next, in step S54, the information processing device 10 performs a process and makes a response based on the result of voice recognition and semantic analysis on the user's speech in step S53. Specifically, the information processing device 10 performs a process of setting an alarm at 12:00, and outputs the following system speech.

System speech=Setting alarm at 12 is done.

(Step S55) The process of step S55 is a process performed at 12:00 which is the alarm setting time.

The information processing device 10 outputs an alarm sound in step S55.

(Step S56)

Next, in step S56, the user says the following user registration speech start keyword 30 minutes after the output of the alarm.

User's speech=Thank you This user's speech corresponds to the user registration keyword I shown in FIG. 7.

(Step S57)

Similarly to the processing example 5 described previously, the present example shows the processing using the user registration speech start keyword I shown in FIG. 7 for causing the information processing device 10 to execute the process of stopping the alarm set by the user. The user registration speech start keyword I is associated with (a) target period=5:00-10:00/duration=60 sec, and (b) target period=10:00-20:00/duration=5 sec.

In the present example, the duration at 12:00 when the alarm is output is 5 sec. Therefore, the information processing device 10 does not assess whether or not the user's speech issued 30 minutes after the alarm output is the user registration speech start keyword. Therefore, the process of stopping the alarm is not performed.

(Steps S57-60)

In this case, the user says the default speech start keyword (Hi, Sony) in step S57, and after the confirmation sound is output from the information processing device 10 in step S58, the user says the following normal speech in step S59.

User's speech=Stop alarm

In step S60, the information processing device 10 performs a process and makes a response based on the result of voice recognition and semantic analysis on the user's speech in step S59. Specifically, the information processing device 10 performs the process of stopping the alarm.

In this way, in a case where the user's speech “Thank you” is issued with a delay during daytime, this user's speech is not acknowledged as the registered speech start keyword.

### Processing Example 7

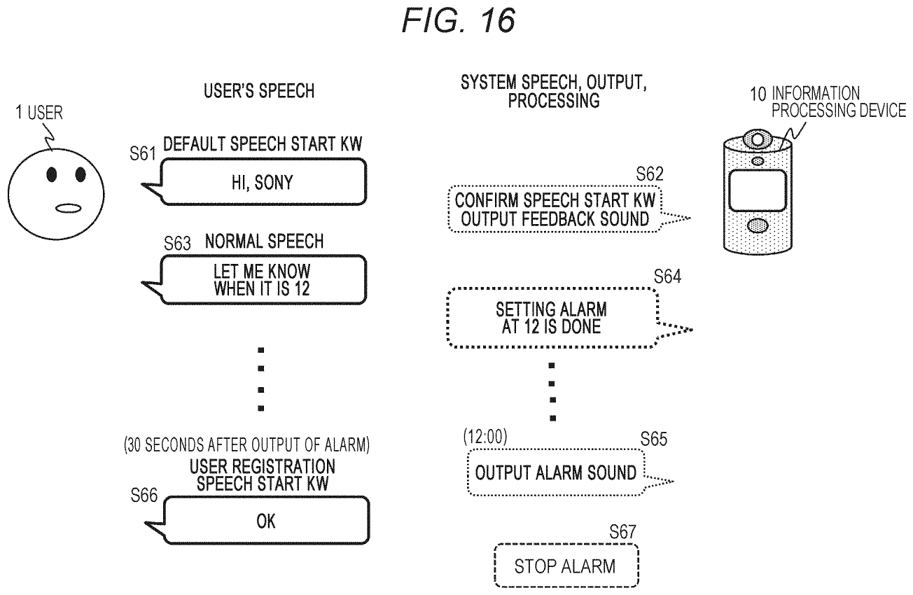

Next, processing example 7 will be described with reference to FIG. 16.

(Step S61)

First, in step S61, the user says the following default speech start keyword.

User's speech=Hi, Sony

(Step S62)

The information processing device 10 assesses, in the default speech start keyword processing unit 122 of the keyword analysis unit 103, that the user's speech in step S61 is the default speech start keyword.

In step S62, the information processing device 10 outputs a confirmation sound (feedback sound) indicating that the device has confirmed the default speech start keyword “Hi, Sony” input by the user on the basis of the assessment. Further, the information processing device 10 makes settings to receive the subsequent user's speech (normal speech) and start voice recognition.

(Step S63)

Next, the user says the following normal speech in step S63.

User's speech=Let me know when it is 12

(Step S64)

Next, in step S64, the information processing device 10 performs a process and makes a response based on the result of voice recognition and semantic analysis on the user's speech in step S63. Specifically, the information processing device 10 performs a process of setting an alarm at 12:00, and outputs the following system speech.

System speech=Setting alarm at 12 is done.

(Step S65)

The process of step S65 is a process performed at 12:00 which is the alarm setting time.

The information processing device 10 outputs an alarm sound in step S65.

(Step S66)

Next, in step S66, the user says the following user registration speech start keyword 30 minutes after the output of the alarm.

User's speech=OK

This user's speech corresponds to the user registration keyword J shown in FIG. 7.

(Step S67)

Similarly to the processing examples 5 and 6 described previously, the present example shows the processing of causing the information processing device 10 to execute the process of stopping the alarm set by the user. However, in this example, the user registration speech start keyword J shown in FIG. 7 is used. The user registration speech start keyword J is associated with (a) target period=5:00-10:00/duration=60 sec, and (b) target period=10:00-20:00/duration=40 sec.

In the present example, the duration at 12:00 when the alarm is output is 40 sec. Therefore, the user's speech issued 30 minutes after the output of the alarm is assessed as the user registration speech start keyword. Therefore, the alarm stop process is executed.

In this way, the duration can be set differently for each registered speech start keyword. Thus, a pattern that cannot be performed with the word “Thank you” can be performed by the word “OK”.

### Processing Example 8

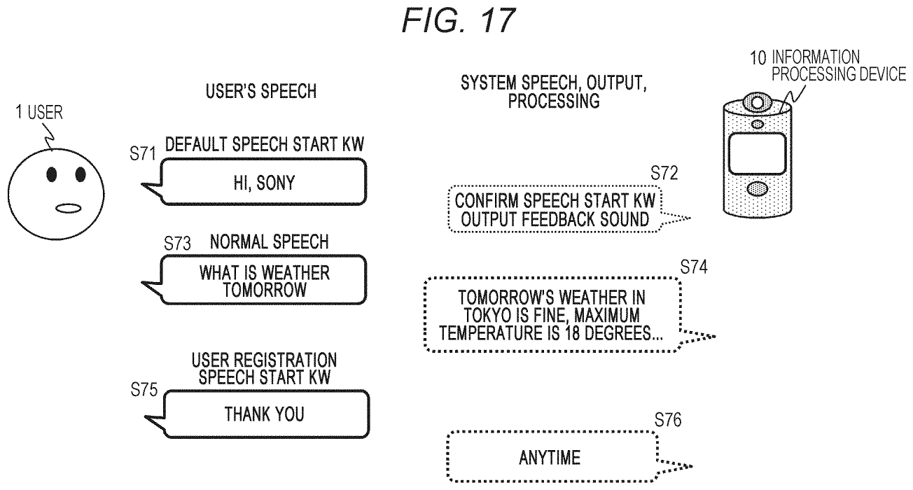

Next, processing example 8 will be described with reference to FIG. 17.

(Step S71)

First, in step S71, the user says the following default speech start keyword.

User's speech=Hi, Sony

(Step S72)

The information processing device 10 assesses, in the default speech start keyword processing unit 122 of the keyword analysis unit 103, that the user's speech in step S71 is the default speech start keyword.

In step S72, the information processing device 10 outputs a confirmation sound (feedback sound) indicating that the device has confirmed the default speech start keyword “Hi, Sony” input by the user on the basis of the assessment. Further, the information processing device 10 makes settings to receive the subsequent user's speech (normal speech) and start voice recognition.

(Step S73)

Next, the user says the following normal speech in step S73.

User's speech=What is the weather tomorrow

(Step S74)

Next, in step S74, the information processing device 10 performs a process and makes a response based on the result of voice recognition and semantic analysis on the user's speech in step S73. Specifically, the information processing device 10 starts a weather application, acquires weather information, and outputs the following system speech.

System speech=Tomorrow's weather in Tokyo is fine, the maximum temperature is 18 degrees . . . .

(Step S75)

Next, in step S75, the user says the following user registration speech start keyword.

User's speech=Thank you

This user's speech corresponds to the user registration keyword K shown in FIG. 7.

(Step S76)

The information processing device 10 assesses, in the user registration speech start keyword processing unit 123 of the keyword analysis unit 103, that the user's speech in step S75 is the user registration speech start keyword. Further, the information processing device 10 outputs the registration information (keyword, execution content, etc.) in the user registration keyword holding unit 104 to the semantic analysis unit 107.

The semantic analysis unit 107 performs semantic analysis on the user's speech based on this input information, and outputs a processing request according to the analysis result to the operation command issuing unit 108. The operation command issuing unit 108 causes the application execution unit to execute the process.

In the example shown in FIG. 17, in step S76, a process (OUTPUT-STOP) of stopping the output of weather information is performed, and further, the following system speech is output.

System speech=Anytime

The registered speech start keyword becomes acceptable when the information processing device 10 takes an action. Therefore, it is possible to stop the system from providing information only by giving feedback such as “Thank you” when the user hears the information he/she wants to know.

### Processing Example 9

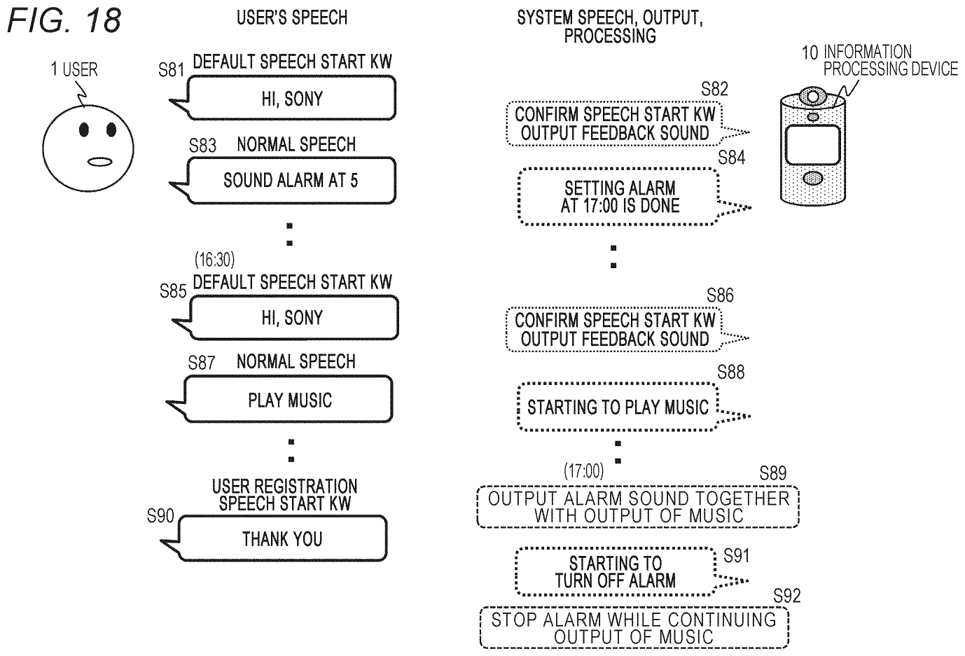

Next, processing example 9 will be described with reference to FIG. 18.

(Step S81)

First, in step S81, the user says the following default speech start keyword.

User's speech=Hi, Sony

(Step S82)

The information processing device 10 assesses, in the default speech start keyword processing unit 122 of the keyword analysis unit 103, that the user's speech in step S81 is the default speech start keyword.

In step S82, the information processing device 10 outputs a confirmation sound (feedback sound) indicating that the device has confirmed the default speech start keyword “Hi, Sony” input by the user on the basis of the assessment. Further, the information processing device 10 makes settings to receive the subsequent user's speech (normal speech) and start voice recognition.

(Step S83)

Next, the user says the following normal speech in step S83.

User's speech=Sound alarm at 5

(Step S84)

Next, in step S84, the information processing device 10 performs a process and makes a response based on the result of voice recognition and semantic analysis on the user's speech in step S83. Specifically, the information processing device 10 sets an alarm and outputs the following system speech.

System speech=Setting alarm at 17:00 is done

(Steps S85 and S86)

Next, in step S85, the user says the following default speech start keyword at 16:30 after some time has elapsed.

User's speech=Hi, Sony

The information processing device 10 outputs a confirmation sound (feedback sound) indicating that the device has confirmed the input of the default speech start keyword “Hi, Sony” by the user. Further, the information processing device 10 makes settings to receive the subsequent user's speech (normal speech) and start voice recognition.

(Step S87)

Next, the user says the following normal speech in step S87.

User's speech=Play music

(Step S88)

Next, in step S88, the information processing device 10 performs a process and makes a response based on the result of voice recognition and semantic analysis on the user's speech in step S87. Specifically, the information processing device 10 starts to play music and outputs the following system speech.

System speech=Starting to play music

(Step S89)

The process of step S89 is a process at 17:00, which is the alarm setting time.

The information processing device 10 outputs an alarm sound together with music in step S89.

(Step S90)

Next, in step S90, the user says the following user registration speech start keyword.

User's speech=Thank you

This user's speech corresponds to the user registration keyword I shown in FIG. 7.

(Steps S91 and S92)

The information processing device 10 assesses, in the user registration speech start keyword processing unit 123 of the keyword analysis unit 103, that the user's speech in step S90 is the user registration speech start keyword. Further, the information processing device 10 outputs the registration information (keyword, execution content, etc.) in the user registration keyword holding unit 104 to the semantic analysis unit 107.

The semantic analysis unit 107 performs semantic analysis on the user's speech based on this input information, and outputs a processing request according to the analysis result to the operation command issuing unit 108. The operation command issuing unit 108 causes the application execution unit to execute the process.

In the example shown in FIG. 18, in steps S91 and S92, the information processing device 10 performs the alarm stop process, continues to output music, and further outputs the following system speech.

System speech=Starting to turn off the alarm

It is to be noted that, since the user registration keyword I shown in FIG. 7 is a keyword set corresponding to the alarm control application, the music play application is not stopped and the music is continued to be played.

### Processing Example 10

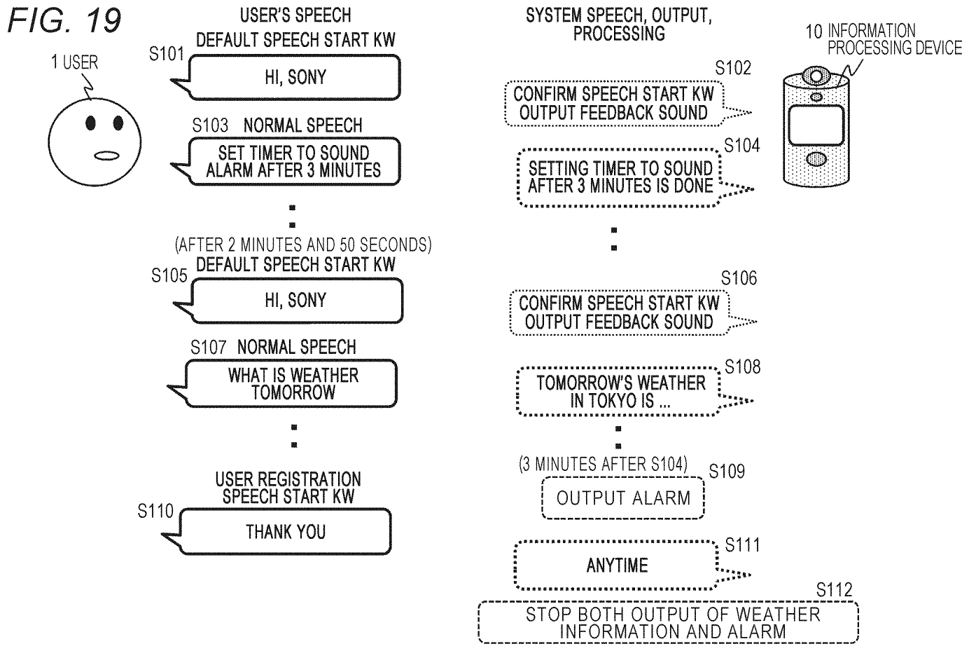

Next, processing example 10 will be described with reference to FIG. 19.

(Step S101)

First, in step S101, the user says the following default speech start keyword.

User's speech=Hi, Sony

(Step S102)

The information processing device 10 assesses, in the default speech start keyword processing unit 122 of the keyword analysis unit 103, that the user's speech in step S101 is the default speech start keyword.

In step S102, the information processing device 10 outputs a confirmation sound (feedback sound) indicating that the device has confirmed the default speech start keyword “Hi, Sony” input by the user on the basis of the assessment. Further, the information processing device 10 makes settings to receive the subsequent user's speech (normal speech) and start voice recognition.

(Step S103)

Next, the user says the following normal speech in step S103.

User's speech=Set timer to sound an alarm after 3 minutes

(Step S104)

Next, in step S104, the information processing device 10 performs a process and makes a response based on the result of voice recognition and semantic analysis on the user's speech in step S103. Specifically, the information processing device 10 sets a timer and outputs the following system speech.

System speech=Setting timer to sound after 3 minutes is done

(Steps S105 and S106)

Next, after 2 minutes and 50 seconds, the user says the following default speech start keyword in step S105.

User's speech=Hi, Sony

The information processing device 10 outputs a confirmation sound (feedback sound) indicating that the device has confirmed the input of the default speech start keyword “Hi, Sony” by the user. Further, the information processing device 10 makes settings to receive the subsequent user's speech (normal speech) and start voice recognition.

(Step S107)

Next, the user says the following normal speech in step S107.

User's speech=What is the weather tomorrow

(Step S108)

Next, in step S108, the information processing device 10 performs a process and makes a response based on the result of voice recognition and semantic analysis on the user's speech in step S107. Specifically, the information processing device 10 starts a weather application, acquires weather information, and outputs the following system speech.

System speech=Tomorrow's weather in Tokyo is . . . .

(Step S109)

The process of step S109 is a process at the alarm output time by the timer.

The information processing device 10 outputs an alarm sound in step S109.

(Steps S110 to S112)

Next, in step S110, the user says the following user registration speech start keyword.

User's speech=Thank you

This user's speech corresponds to the user registration keyword I and the user registration keyword K shown in FIG. 7.

That is, in the information processing device 10, the same user registration keyword I and user registration keyword K are recorded to two applications currently being executed, that is, (1) alarm (timer) control application and (2) weather information providing application, but different execution contents are recorded thereto.

The execution content of (1) alarm (timer) control application is stopping an alarm (ALARM-STOP), and the execution content of (2) weather information providing application is stopping the output (OUTPUT-STOP).

The information processing device 10 applies these two execution contents to the respective applications.

Specifically, in steps S111 and S112, the information processing device 10 stops the output of weather information, stops the alarm output, and further outputs the following system speech.

System speech=Anytime

In this way, even in a case where the time and state in which the registered speech start keyword can be received overlap among a plurality of applications, the processing according to the execution content corresponding to each application is executed.

It should be noted that priorities can be placed on applications in advance by the user, and only one of the applications may be terminated.

For example, priorities may be placed on the plurality of user registration speech start keywords shown in FIGS. 6 and 7, and only the top keyword or the top two keywords may be executed.

### 4. Sequence of Processing Executed by Information Processing Device

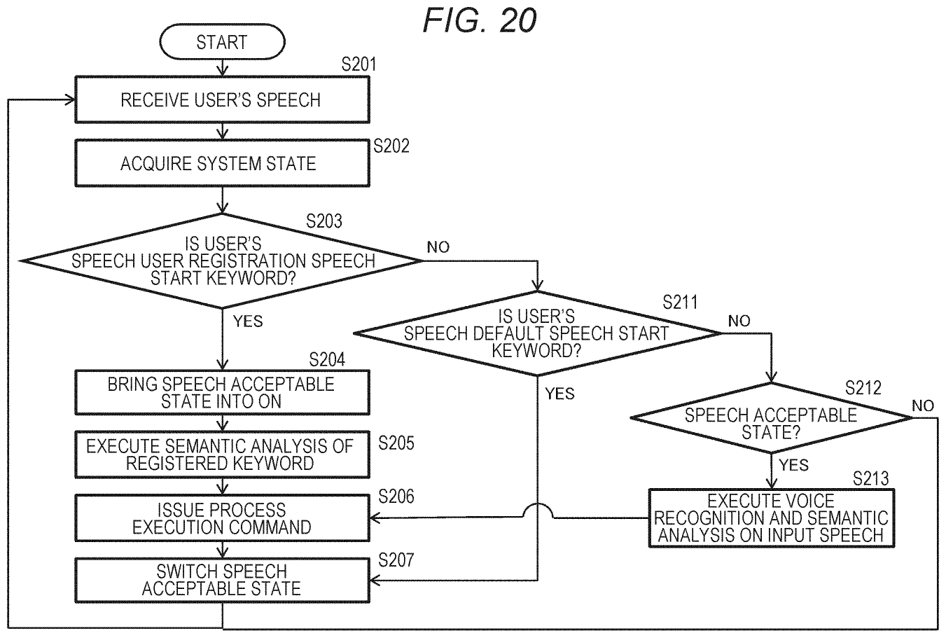

Next, a sequence of processing executed by the information processing device 10 will be described with reference to the flowchart shown in FIG. 20.

The processing according to the flowchart illustrated in FIG. 20 is executed in accordance with a program stored in the storage unit of the information processing device 10, for example. For example, it can be executed as a program execution process by a processor such as a CPU having a program execution function.

The process of each step of the flowchart shown in FIG. 20 will be described.

(Step S201)

First, the information processing device 10 receives a user's speech in step S201.

This process is executed by the voice input unit 101 of the information processing device 10 shown in FIG. 3.

The user's speech is input to the keyword analysis unit 103 via the voice input unit 101.

(Step S202)

Next, the information processing device 10 acquires a system state in step S202.

This process is executed by the system state grasping unit 102 of the information processing device 10 shown in FIG. 3.

As described previously, the “system state information” generated by the system state grasping unit 102 includes the external information of the information processing device 10 and the internal information of the information processing device 10.

The external information includes, for example, time period, position (for example, GPS) information, external noise intensity information, and the like.

On the other hand, the internal information includes status information of an application controlled by the information processing device 10, for example, whether or not the application is being executed, the type of the executed application, setting information of the application, and the like.

The “system state information” generated by the system state grasping unit 102 is output to the keyword analysis unit 103.

(Step S203)

Next, in step S203, it is assessed whether or not the input user's speech is a user registration speech start keyword.

This process is executed by the user registration speech start keyword processing unit 123 of the keyword analysis unit 103 shown in FIG. 3.

The user registration speech start keyword processing unit 123 assesses whether or not the voice signal input to the voice input unit (microphone) 101 by the user is a voice signal corresponding to the user registration speech start keyword registered in advance.

The user registration speech start keyword processing unit 123 in the keyword analysis unit 103 receives the following information sets from the speech start keyword recognition unit 121.

(a) Voice signal of user's speech

(b) “System state information” input from the system state grasping unit 101

The user registration speech start keyword processing unit 123 assesses whether or not the voice signal input by the user to the voice input unit (microphone) 101 is the registered user registration speech start keyword stored in the user registration keyword holding unit 104.

As described with reference to FIGS. 6 and 7, various speech start keywords of the user are registered in the user registration keyword holding unit 104 in association with various applications.

Further, the user registration keyword holding unit 104 also has recorded therein a target period and duration for which the assessment process for assessing that the user's speech is the user registration speech start keyword is executed.

In step S203, the application being executed in the information processing device 10 is confirmed, and processing in further consideration of the target period and the duration is performed.

When it is assessed that the input user's speech is the user registration speech start keyword after the application being executed in the information processing device 10 is confirmed and the target period and the duration are also considered, the processing proceeds to step S204.

On the other hand, when the user's speech is assessed not to be the user registration speech start keyword, the processing proceeds to step S211.

It is to be noted that the case where the user's speech is not assessed to be the user registration speech start keyword includes a case where, for example, the timing of the user's speech does not fall within the target period or the duration.

(Step S204)

When it is assessed in step S203 that the user's speech is the user registration speech start keyword, the processing proceeds to step S204.

In step S204, the speech acceptable state is brought into ON. That is, the information processing device 10 is brought into a state capable of executing voice recognition and semantic analysis to be performed later on the user's speech.

(Step S205)

Next, in step S205, the information processing device 10 executes the semantic analysis process of the input user's speech, that is, the user registration speech start keyword.

This process is executed by the semantic analysis unit 107 shown in FIG. 3.

When the user's speech is assessed to be the user registration speech start keyword, the user registration speech start keyword processing unit 123 outputs, to the semantic analysis unit 107, the keyword stored in the user registration keyword holding unit 103 and information associated with the keyword.

The semantic analysis unit 107 executes the semantic analysis of the user's speech on the basis of these information sets. The analysis result (for example, the operation command and attached information which is a parameter thereof) is output to the operation command issuing unit 108.

(Step S206)

Next, in step S206, the information processing device 10 performs a process of issuing a process execution command.

This process is executed by the operation command issuing unit 108 shown in FIG. 3.

The operation command issuing unit 108 outputs the process execution command for causing the process execution unit to execute a process according to the user request to the process execution unit in accordance with the semantic analysis result (for example, the operation command and the attached information which is a parameter thereof) input from the semantic analysis unit 107.

(Step S207)

Next, in step S207, the information processing device 10 performs a process of switching the speech acceptable state.

This process is executed by the internal state switching unit 109 shown in FIG. 3.

The state of the system (information processing device 10) is either of the following two states:

(a) Speech awaiting stop state in which voice recognition process is not performed on user's speech; and

(b) Speech awaiting state in which voice recognition process is performed on user's speech.

In step S206, when the operation command issuing unit 108 issues the process execution command, the information processing device 10 is in (b) speech awaiting state in which voice recognition process is performed on the user's speech. Therefore, the process of changing this state to (a) speech awaiting stop state in which voice recognition process is not performed on the user's speech is performed.

Next, processes in step S211 and subsequent steps in a case where the user's speech is not assessed to be the user registration speech start keyword in step S203 will be described.

(Step S211)

When it is assessed in step S203 that the user's speech is not the user registration speech start keyword, the information processing device 10 assesses in step S211 whether or not the user's speech is the default speech start keyword.

This process is executed by the default speech start keyword processing unit 122 of the keyword analysis unit 103 shown in FIG. 3.

The default speech start keyword processing unit 122 assesses whether or not the voice signal input to the voice input unit (microphone) 101 by the user is a voice signal corresponding to the default speech start keyword registered in advance.

The default speech start keyword processing unit 122 in the keyword analysis unit 103 receives, from the speech start keyword recognition unit 121, the following information sets.

(a) Voice signal of user's speech

(b) “System state information” input from system state grasping unit 101

Then, the default speech start keyword processing unit 122 executes a recognition process of assessing whether or not the input user's speech is the default speech start keyword preset to the system (information processing device 10).

The default speech start keyword is a keyword such as “Hi, Sony” described previously with reference to FIG. 1.

When it is assessed that the user's speech is the default speech start keyword, the processing proceeds to step S207.

In step S207, the internal state switching process is performed for switching the state of the system (information processing device 10) between the following two states:

(a) Speech awaiting stop state in which voice recognition process is not performed on user's speech;

and

(b) Speech awaiting state in which voice recognition process is performed on user's speech.

On the other hand, when it is assessed in step S211 that the user's speech is not the default speech start keyword, the processing proceeds to step S212.

(Step S212)

When it is assessed in step S211 that the user's speech is not the default speech start keyword, the processing proceeds to step S212.

Note that the user's speech in this case is a normal speech that is neither the user registration speech start keyword nor the default speech start keyword.

In step S212, the information processing device 10 assesses whether or not the state of the information processing device 10 is (b) speech awaiting state in which voice recognition process is performed on user's speech.

If the information processing device 10 is in the speech awaiting state, the processing proceeds to step S213.

On the other hand, if the information processing device 10 is not in the speech awaiting state, the processing returns to step S201 without performing any process.

(Step S213)

In step S212, when it is assessed that the state of the information processing device 10 is (b) speech awaiting state in which voice recognition process is performed on the user's speech, the processing proceeds to step S213 where the voice recognition process and semantic analysis process of the user's speech are performed.

This process is executed by the voice recognition unit 106 and the semantic analysis unit 107 shown in FIG. 3.

The voice recognition unit 106 executes a voice recognition process of converting the voice waveform of the user's speech input from the voice input unit (microphone) 101 into a character string.

The semantic analysis unit 107 estimates a semantic system and a semantic expression that the system (information processing device 10) can process the character string input from the voice recognition unit 106. The semantic system and the semantic expression are expressed in the form of “operation command” that the user intends to execute and “attached information” that is a parameter thereof.

After this process, the processing proceeds to step S206 where a process execution command is issued.

As described with reference to the flowchart, the information processing device according to the present disclosure categorizes the user's speech into three, that is,

(1) user registration speech start keyword,

(2) default speech start keyword, and

(3) normal speech, and

performs a process according to each categorization.

### 5. Configuration Examples of Information Processing Device and Information Processing System

While the processing executed by the information processing device 10 according to the present disclosure has been described above, the processing functions of the components of the information processing device 10 illustrated in FIG. 3 may be all included in one device, for example, an agent device, a smartphone, a personal computer (PC) of the user, etc. or a part of the processing functions may be executed by a server, etc.

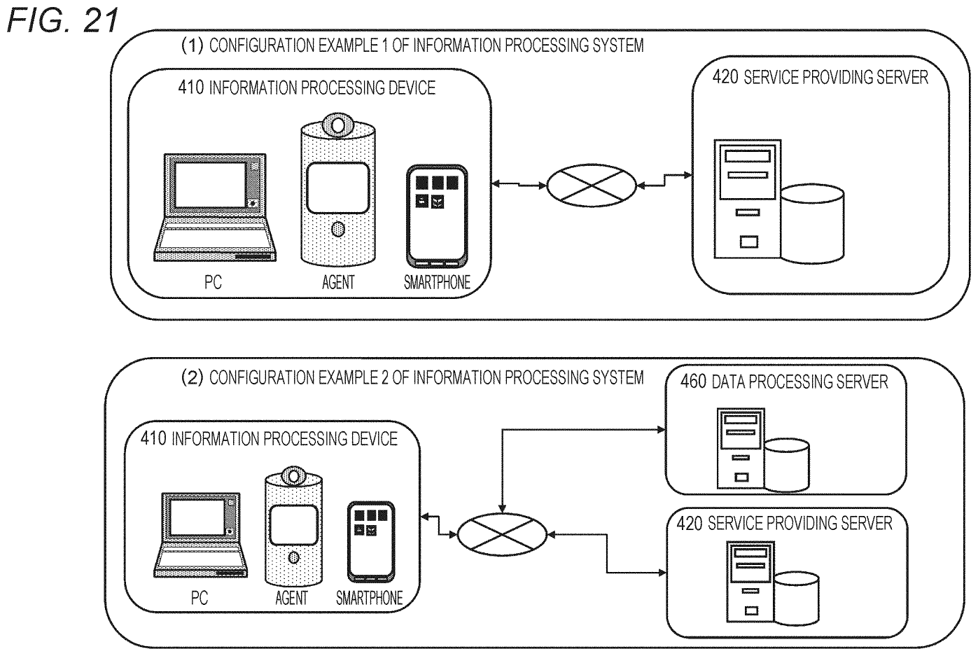

FIG. 21 shows a configuration example of the system.

The configuration example 1 of the information processing system in part (1) of FIG. 21 shows that almost all functions of the information processing device shown in FIG. 3 are included in one device, for example, an information processing device 410 which is a user terminal such as a smartphone or PC carried by the user or an agent device having a voice input/output function and an image input/output function.

The information processing device 410 corresponding to the user terminal communicates with a service providing server 420 only in a case where the information processing device 410 uses an external service when, for example, creating an answer sentence.

The service providing server 420 is, for example, a music providing server, a content (movie or the like) providing server, a game server, a weather information providing server, a traffic information providing server, a medical information providing server, a sightseeing information providing server, and the like, and is constituted by a group of servers capable of providing information necessary for executing a process in response to the user's speech and generating a response.

On the other hand, the configuration example 2 of the information processing system in part (2) of FIG. 21 shows that a part of the functions of the information processing device shown in FIG. 3 is included in the information processing device 410 which is a user terminal such as a smartphone or PC carried by the user or an agent device, and another part of the functions is executed by a data processing server 460 capable of communicating with the information processing device.

For example, the system may have various configurations such as a configuration in which only the voice input unit (microphone) 101 or an output unit (not shown) in the device shown in FIG. 3 is provided in the information processing device 410 of the user terminal, and the other functions are executed by the server.

In addition, various different settings are possible regarding a mode for assigning functions between the user terminal and the server. Further, one function may be executed by both the user terminal and the server.

### 6. Example of Hardware Configuration of Information Processing Device

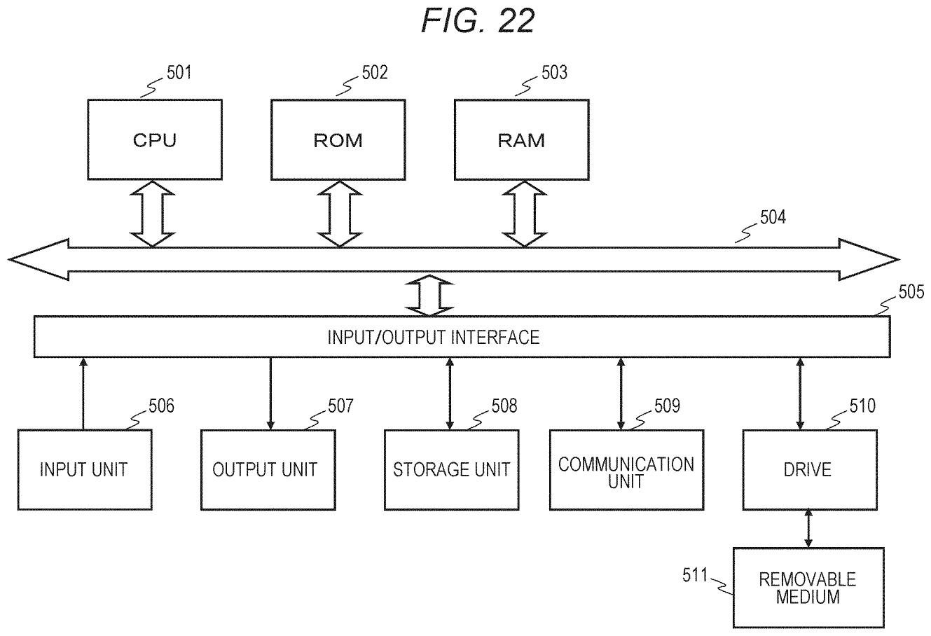

Next, an example of a hardware configuration of the information processing device will be described with reference to FIG. 22.

The example described with reference to FIG. 22 shows an example of the hardware configuration of the information processing device described above with reference to FIG. 3, and also shows an example of the hardware configuration of the information processing device constituting the data processing server 460 described with reference to FIG. 21.

A central processing unit (CPU) 501 functions as a control unit or a data processing unit that executes various kinds of processing according to a program stored in a read only memory (ROM) 502 or a storage unit 508.

For example, the CPU 501 executes the processing according to the sequence described in the above embodiment. A random access memory (RAM) 503 stores programs executed by the CPU 501, data, and the like. The CPU 501, ROM 502, and RAM 503 are interconnected by a bus 504.

The CPU 501 is connected to an input/output interface 505 via the bus 504. The input/output interface 505 is connected to an input unit 506 including various switches, a keyboard, a mouse, a microphone, a sensor, and the like, and an output unit 507 including a display, a speaker, and the like. The CPU 501 executes various kinds of processing in response to a command input from the input unit 506, and outputs a processing result to, for example, the output unit 507.

The storage unit 508 connected to the input/output interface 505 includes, for example, a hard disk, etc., and stores a program executed by the CPU 501 and various kinds of data. The communication unit 509 functions as a transmission/reception unit for Wi-Fi communication, Bluetooth (registered trademark) (BT) communication, and other data communication via a network such as the Internet or a local area network, and communicates with an external device.

A drive 510 connected to the input/output interface 505 drives a removable medium 511 such as a magnetic disk, an optical disk, a magneto-optical disk, or a semiconductor memory such as a memory card to record or read data.

### 7. Summary of Configuration of Present Disclosure

The embodiment of the present disclosure has been described above in detail with reference to the specific embodiments. However, it is obvious that those skilled in the art can modify or substitute the embodiment without departing from the scope of the present disclosure. That is, the present invention has been disclosed in the form of illustrative modes, and should not be construed as restrictive. In order to determine the gist of the present disclosure, the scope of claims should be taken into consideration.

Note that the technology described in the present specification can be configured as follows.

(1) An information processing device including

a keyword analysis unit that assesses whether or not a user's speech is a speech start keyword,

in which the keyword analysis unit includes a user registration speech start keyword processing unit that assesses whether or not the user's speech is a user registration speech start keyword that is registered in advance by a user, and

the user registration speech start keyword processing unit assesses that the user's speech is the user registration speech start keyword only in a case where the user's speech is similar to a pre-registered keyword and satisfies a registration condition registered in advance.

(2) The information processing device according to (1),

in which the registration condition is an application that is being executed in the information processing device, and

the user registration speech start keyword processing unit assesses that the user's speech is the user registration speech start keyword, in a case where an application associated with the pre-registered keyword is being executed.

(3) The information processing device according to (1) or (2),

in which the registration condition is an input time of the user's speech, and

the user registration speech start keyword processing unit assesses that the user's speech is the user registration speech start keyword, in a case where an input time of the user's speech falls within a target period registered in association with the pre-registered keyword.

(4) The information processing device according to any one of (1) to (3),

in which the registration condition is an input timing of the user's speech, and

the user registration speech start keyword processing unit assesses that the user's speech is the user registration speech start keyword, in a case where an input timing of the user's speech falls within a duration registered in association with the pre-registered keyword.

(5) The information processing device according to (4),

in which the duration is an elapsed time after one process by the application that is being executed in the information processing device ends.

(6) The information processing device according to any one of (1) to (5),

in which, when assessing that the user's speech is the user registration speech start keyword, the user registration speech start keyword processing unit outputs execution content information indicating an execution content registered in association with the user registration speech start keyword to a semantic analysis unit in order to cause the information processing device to execute a process corresponding to the execution content.

(7) The information processing device according to (6),

in which the semantic analysis unit outputs an operation command for causing the information processing device to execute a process according to the user's speech to an operation command issuing unit on the basis of the execution content information input from the user registration speech start keyword processing unit.

(8) The information processing device according to any one of (1) to (7),

in which the keyword analysis unit includes a default speech start keyword processing unit that assesses whether or not the user's speech is a default speech start keyword other than the user registration speech start keyword.

(9) An information processing system including: a user terminal; and a data processing server,

in which the user terminal includes a voice input unit that receives a user's speech,

the data processing server includes a user registration speech start keyword processing unit that assesses whether or not the user's speech received from the user terminal is a user registration speech start keyword that is registered in advance by a user, and

the user registration speech start keyword processing unit assesses that the user's speech is the user registration speech start keyword only in a case where the user's speech is similar to a pre-registered keyword and satisfies a registration condition registered in advance.

(10) An information processing method executed by an information processing device,

in which a user registration speech start keyword processing unit performs a user registration speech start keyword assessment step for assessing whether or not the user's speech is a user registration speech start keyword that is registered in advance by a user, and

in the user registration speech start keyword assessment step, the user's speech is assessed to be the user registration speech start keyword only in a case where the user's speech is similar to a pre-registered keyword and satisfies a registration condition registered in advance.

(11) An information processing method executed by an information processing system that includes a user terminal and a data processing server,

in which the user terminal executes a voice input process of receiving a user's speech,

the data processing server executes a user registration speech start keyword assessment process of assessing whether or not the user's speech received from the user terminal is a user registration speech start keyword that is registered in advance by a user, and

in the user registration speech start keyword process, the user's speech is assessed to be the user registration speech start keyword only in a case where the user's speech is similar to a pre-registered keyword and satisfies a registration condition registered in advance.

(12) A program that causes an information processing device to execute information processing,

the program causing a user registration speech start keyword processing unit to execute a user registration speech start keyword assessment step for assessing whether or not the user's speech is a user registration speech start keyword that is registered in advance by a user, and

causing the user registration speech start keyword processing unit to assess that the user's speech is the user registration speech start keyword in the user registration speech start keyword assessment step, only in a case where the user's speech is similar to a pre-registered keyword and satisfies a registration condition registered in advance.

Further, a series of processing described in the specification can be executed by hardware, software, or a configuration obtained by combining hardware and software. When the processing is performed by software, a program having a processing sequence recorded therein can be executed by being installed in a memory built in dedicated hardware in a computer, or by being installed in a general-purpose computer capable of executing various kinds of processing. For example, the program can be recorded in a recording medium in advance. The program can be installed in the computer from the recording medium, or the program can be received through a network such as a local area network (LAN) or the Internet to be installed in the recording medium such as a built-in hard disk.

It is to be noted that the various kinds of processing described in the specification is not necessarily performed sequentially in the orders described in the specification, and may be performed simultaneously or individually according to the processing capacity of a device that executes the processing or as necessary. Further, the system in the present specification refers to a logical set of multiple devices, and the respective devices are not limited to be housed within a single housing.

### INDUSTRIAL APPLICABILITY

As described above, according to the configuration of the embodiment of the present disclosure, a device and method that enable the execution of processing requested by a user based on a natural user's speech without using an unnatural default speech start keyword can be achieved.

Specifically, for example, a keyword analysis unit is provided that assesses whether or not the user's speech is a speech start keyword, and the keyword analysis unit has a user registration speech start keyword processing unit that assesses whether or not the user's speech is a user registration speech start keyword registered by a user in advance. The user registration speech start keyword processing unit assesses that the user's speech is the user registration speech start keyword, in a case where the user's speech is similar to a pre-registered keyword, and a pre-registered registration condition, such as an application being executed, or an input time or input timing of the user's speech, satisfies a registration condition.

With this configuration, the device and method that enable the execution of processing requested by a user based on a natural user's speech without using an unnatural default speech start keyword can be achieved.

### REFERENCE SIGNS LIST

10 Information processing device
12 Microphone
13 Display unit
14 Speaker
20 Server
30 External device
101 Voice input unit
102 System state grasping unit
103 Keyword analysis unit
104 User registration keyword holding unit
105 User registration keyword management unit
106 Voice recognition unit
107 Semantic analysis unit
108 Operation command issuing unit
109 Internal state switching unit
121 Speech start keyword recognition unit
122 Default speech start keyword processing unit
123 User registration speech start keyword processing unit
410 Information processing device
420 Service providing server
460 Data processing server
501 CPU
502 ROM
503 RAM
504 Bus
505 Input/output interface
506 Input unit
507 Output unit
508 Storage unit
509 Communication unit
510 Drive
511 Removable medium

1. An information processing device comprising
a keyword analysis unit that assesses whether or not a user's speech is a speech start keyword,
wherein the keyword analysis unit includes a user registration speech start keyword processing unit that assesses whether or not the user's speech is a user registration speech start keyword that is registered in advance by a user, and
the user registration speech start keyword processing unit assesses that the user's speech is the user registration speech start keyword only in a case where the user's speech is similar to a pre-registered keyword and satisfies a registration condition registered in advance.

2. The information processing device according to claim 1,
wherein the registration condition is an application that is being executed in the information processing device, and
the user registration speech start keyword processing unit assesses that the user's speech is the user registration speech start keyword, in a case where an application associated with the pre-registered keyword is being executed.

3. The information processing device according to claim 1,
wherein the registration condition is an input time of the user's speech, and
the user registration speech start keyword processing unit assesses that the user's speech is the user registration speech start keyword, in a case where an input time of the user's speech falls within a target period registered in association with the pre-registered keyword.

4. The information processing device according to claim 1,
wherein the registration condition is an input timing of the user's speech, and
the user registration speech start keyword processing unit assesses that the user's speech is the user registration speech start keyword, in a case where an input timing of the user's speech falls within a duration registered in association with the pre-registered keyword.

5. The information processing device according to claim 4,
wherein the duration is an elapsed time after one process by the application that is being executed in the information processing device ends.

6. The information processing device according to claim 1,
wherein, when assessing that the user's speech is the user registration speech start keyword, the user registration speech start keyword processing unit outputs execution content information indicating an execution content registered in association with the user registration speech start keyword to a semantic analysis unit in order to cause the information processing device to execute a process corresponding to the execution content.

7. The information processing device according to claim 6,
wherein the semantic analysis unit outputs an operation command for causing the information processing device to execute a process according to the user's speech to an operation command issuing unit on a basis of the execution content information input from the user registration speech start keyword processing unit.

8. The information processing device according to claim 1,
wherein the keyword analysis unit includes a default speech start keyword processing unit that assesses whether or not the user's speech is a default speech start keyword other than the user registration speech start keyword.

9. An information processing system comprising: a user terminal; and a data processing server,
wherein the user terminal includes a voice input unit that receives a user's speech,
the data processing server includes a user registration speech start keyword processing unit that assesses whether or not the user's speech received from the user terminal is a user registration speech start keyword that is registered in advance by a user, and
the user registration speech start keyword processing unit assesses that the user's speech is the user registration speech start keyword only in a case where the user's speech is similar to a pre-registered keyword and satisfies a registration condition registered in advance.

10. An information processing method executed by an information processing device,
wherein a user registration speech start keyword processing unit performs a user registration speech start keyword assessment step for assessing whether or not the user's speech is a user registration speech start keyword that is registered in advance by a user, and
in the user registration speech start keyword assessment step, the user's speech is assessed to be the user registration speech start keyword only in a case where the user's speech is similar to a pre-registered keyword and satisfies a registration condition registered in advance.

11. An information processing method executed by an information processing system that includes a user terminal and a data processing server,
wherein the user terminal executes a voice input process of receiving a user's speech,
the data processing server executes a user registration speech start keyword assessment process of assessing whether or not the user's speech received from the user terminal is a user registration speech start keyword that is registered in advance by a user, and
in the user registration speech start keyword process, the user's speech is assessed to be the user registration speech start keyword only in a case where the user's speech is similar to a pre-registered keyword and satisfies a registration condition registered in advance.

12. A program that causes an information processing device to execute information processing,
the program causing a user registration speech start keyword processing unit to execute a user registration speech start keyword assessment step for assessing whether or not the user's speech is a user registration speech start keyword that is registered in advance by a user, and
causing the user registration speech start keyword processing unit to assess that the user's speech is the user registration speech start keyword in the user registration speech start keyword assessment step, only in a case where the user's speech is similar to a pre-registered keyword and satisfies a registration condition registered in advance.
